(19) United States
(12) Patent Application Publication
(10) Pub. No.: US 2024/0098712 A1
(43) Pub. Date: Mar. 21, 2024

(54) COMMUNICATION APPARATUS AND COMMUNICATION METHOD FOR COORDINATED SERVICE PERIODS

(71) Applicant: PANASONIC INTELLECTUAL PROPERTY CORPORATION OF AMERICA, Torrance, CA (US)

(72) Inventors: Rojan CHITRAKAR, Singapore (SG); Yoshio URABE, Nara (JP); Yanyi DING, Singapore (SG)

(21) Appl. No.: 18/257,073

(22) PCT Filed: Mar. 10, 2021
(86) PCT No.: PCT/SG2021/050123

§ 371 Date: Jun. 12, 2023

(30) Foreign Application Priority Data
Dec. 15, 2020 (SG) 10202012604Q

(51) Int. Cl. H04W 72/0446; H04L 5/00

(52) U.S. Cl. CPC H04W 72/0446; H04L 5/0035

(57) ABSTRACT

Communication devices and methods for Coordinated Service Periods (SPs) are provided. The first aspect provides a first Access Point (AP) comprising: circuitry, which in operation, generates a request frame indicating a request to setup one or more Coordinated SPs; and a transmitter, which in operation, transmits the request frame to a second AP. The second aspect provides a non-AP STA comprising: a receiver receives a Beacon frame or an Action frame from its associated AP, circuitry extracts information of coordinated SPs from the frame and a transmitter, transmits a request frame to the AP indicating a request to join the SPs.

### BACKGROUND

### 1. Technical Field

The present embodiments generally relate to communication apparatuses, and more particularly relate to methods and apparatuses for Coordinated Service Periods (SPs).

### 2. Description of the Related Art

In the standardization of next generation wireless local area network (WLAN), a new radio access technology having backward compatibilities with IEEE 802.11a/b/g/n/ac/ax technologies has been discussed in the IEEE 802.11be Task Group.

In 11ax High Efficiency (HE) WLAN, multiple frame transmission in a transmission opportunity (TXOP) is supported enabling a station (STA) to transmit additional frames in a transmit queue. In 11be Extremely High Throughput (EHT) WLAN, in order to improve throughput over flax HE WLAN, especially for cell-edge STAs, it has been proposed to enable coordinated transmissions such as coordinated orthogonal frequency-division multiple access (C-OFDMA), coordinated time-division multiple access (C-TDMA), coordinated beamforming (C-BF), coordinated Spatial Reuse (C-SR), coordinated multi user multiple input multiple output (C-MU-MIMO) etc. in a multi-AP system.

Various Multi-AP coordination schemes are being considered in IEEE 802.11be. For coordinated scheduling in time domain, access providers (APs) coordinate their transmission timing. In coordinated Spatial Reuse (SR), APs coordinate their transmission power. In C-OFDMA, APs coordinate resource unit (RU) assignment. In coordinated beamforming (BF), APs coordinate BF. In coordinated multi user multiple input multiple output (MU-MIMO) (also known as joint transmission), APs coordinate their MU-MIMO transmissions.

However, there has been no discussion so far concerning coordinated service periods (SPs).

There is thus a need for communication apparatuses and methods that can solve the above mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for Coordinated SPs.

According to an aspect of the present disclosure, there is provided a first Access Point (AP) comprising: circuitry, which in operation, generates a request frame indicating a request to setup one or more Coordinated service periods (SPs); and a transmitter, which in operation, transmits the request frame to a second AP.

According to another aspect of the present disclosure, there is provided a non-AP STA, comprising: a receiver, which in operation, receives one of a Beacon frame or Action frame from its associated AP; circuitry, which in operation, extracts information of SPs for coordinated transmissions from the frame; and a transmitter, which in operation, transmits a request frame to the AP, the request frame indicating a request to join the SPs.

According to another aspect of the present disclosure, there is provided a method comprising: generating a request frame indicating a request to setup one or more Coordinated SPs; and transmitting the request frame to an AP.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 shows a flow diagram illustrating communications using enhanced service periods for prioritized traffic according to an example.

FIG. 2 illustrates an example of coordinated service periods for Multi-AP Coordinated transmission.

FIG. 3 and FIG. 4 show overlapping wireless networks each of which can include at least one access point (AP) and at least one communication apparatus according to an example.

FIG. 5 illustrates EHT Action frames according to an example.

FIG. 6 illustrates an AP Coordination Session Action frame according to an example.

FIG. 7 depicts a coordinated transmission sequence according to an example.

FIG. 8 depicts a coordinated transmission sequence according to another example.

FIG. 9 illustrates an example of a Coordinated SP transmission.

FIG. 10 shows an example of a TWT Setup frame for TWT Request/Response that are used to setup coordinated SPs.

FIG. 11 illustrates another example of a Coordinated SP transmission.

FIG. 12 illustrates an example of an Ethertype 89-0d data frame that is used for Multi-AP Buffer Status Report.

FIG. 13 illustrates an example of an EHT capabilities element.

FIG. 14 illustrates another example of an 802.11 data frame used for setup of coordinated SPs.

FIG. 15 illustrates another example of a Coordinated SP transmission.

FIG. 16 illustrates an example of a Coordinated SP Request Action frame.

FIG. 17 illustrates an example table of Coordinated SP Type values.

FIG. 18 illustrates an example of a Coordinated SP Response Action frame.

FIG. 19 illustrates an example of a TWT Setup frame that is used to setup Multi-AP Coordinated TWT SPs.

FIG. 20 illustrates an example of a TWT Element that is used to setup Multi-AP Coordinated TWT SPs for C-TDMA.

FIG. 21 illustrates an example diagram of coordinated SPs for C-TDMA.

FIG. 22 illustrates an example diagram of coordinated SPs for C-TDMA+C-OFDMA.

FIG. 23 illustrates an example of a Coordinated SP transmission with Enhanced TWT SPs.

FIG. 24 illustrates another example of a Coordinated SP transmission with Enhanced TWT SPs.

FIG. 25 illustrates an example of a data frame with “Ethertype 89-0d” frame body for requesting or sharing information of an AP's Service Period/s with other APs.

FIG. 26 illustrates another example table of Coordinated SP Type values.

FIG. 27 illustrates an example of a TWT SP Information Request/Response Action frame for requesting or sharing information of an AP's Service Period/s with other APs.

FIG. 28 illustrates an example of a C-TDMA transmission with broadcast enhanced TWT SP.

FIG. 29 illustrates a TWT Setup frame that may be utilised via individual TWT Setup to join another AP's existing TWT SP.

FIG. 30 illustrates a TWT Setup frame that may be utilised for enabling APs to join other AP's Scheduled broadcast SPs of interest.

FIG. 31 illustrates an example diagram illustrating use of Sub-SPs to protect sensitive traffic.

FIG. 32 illustrates a configuration of a communication device, for example a communication apparatus, for example a Sharing AP or a Shared AP, in accordance with various embodiments.

FIG. 33 illustrates a configuration of a communication device, for example a communication apparatus, for example a non-AP STA, in accordance with various embodiments.

FIG. 34 shows a flow diagram illustrating a method for Coordinated SPs according to various embodiments.

FIG. 35 shows a schematic, partially sectioned view of an AP or STA that can be implemented for Coordinated SPs in accordance with various embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

Shared Transmission Opportunity (TXOP) based Multi-AP coordination has been accepted in 802.11be, wherein APs perform coordinated transmission within a shared TXOP. Examples include shared TXOP based C-OFDMA/C-time domain multiple access (C-TDMA), and shared TXOP based C-SR.

In Singapore patent application no. 10202012139Q), mechanisms to protect Prioritized traffic within enhanced target wait times (TWTs) (e.g. Low latency or National Security and Emergency Preparedness (NSEP) traffic) by restricting the channel access (from non-designated traffic) within the basic service set (B S S) are discussed.

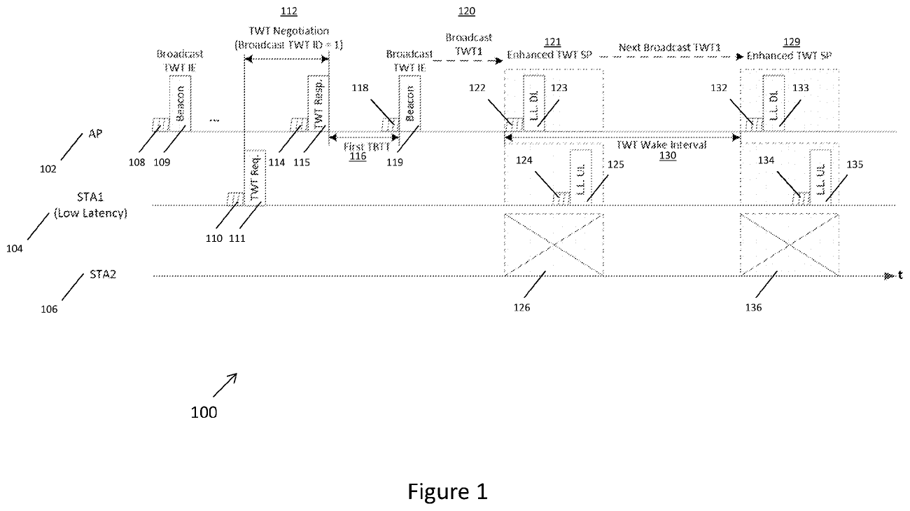

For example, FIG. 1 shows a flow diagram 100 illustrating communications using enhanced service periods for prioritized traffic according to an example. Contention based channel access procedures, e.g. enhanced distributed channel access (EDCA) procedures, are illustrated by blocks 108, 110, 114, 118, 122, 124, 132, 134. For simplicity, acknowledgment frames (e.g. ACK, BlockAck frames) are not explicitly illustrated but they are understood to exist where required. AP 102 may transmit a Beacon frame 109 to advertise existence of Enhanced TWT SPs 121, 129, where only low latency traffic is allowed in the Enhanced TWT SPs 121, 129. Any STAs, which need to access channel during the Enhanced TWT SPs 121, 129, such as STA1 104, may then negotiate membership for the Enhanced TWT SPs 121, 129 with AP 102 through TWT request/response frames exchange. In particular, during TWT negotiation phase 112, STA1 104 transmits a TWT request frame to AP 102 requesting a membership for the Enhanced TWT SPs 121, 129 while the AP 102 then transmit a TWT response frame to STA1 104 granting the membership. In the TWT negotiation phase 117, STA1 104 can request, suggest or demand a set of TWT parameters of the Enhanced TWT SPs 121, 129 and AP 102 can accept or reject, or proposed an alternative setting. First target beacon transmission time (TBTT) 116 may also be negotiated during the negotiation phase 112. As such, STA1 is now allowed to access channel and exchange low latency traffic during the Enhanced TWT SPs 121, 129. The Broadcast TWT ID field of a TWT element included in the TWT request frame or the TWT response frame is set to a non-zero value (e.g. 1) to indicate a broadcast TWT.

STA1 may go to doze state and wakes up after First TBTT 116 to receive a Beacon frame 119 from AP 102. The Beacon frame 119 may comprise a Broadcast TWT element which includes further TWT information such as Broadcast TWT (e.g. Broadcast TWT1 120), TWT Wake Interval 130 and minimum TWT wake up duration (as indicated in dashed line boxes for the Enhanced TWT SP 121, 129). The TWT element further indicates that this is an Enhanced TWT and only Low Latency traffic is allowed to be transmitted during this TWT SP.

STA1 may go to sleep after receiving the Beacon frame 119 and wake up for the Broadcast TWT1 SP 121. Since STA1 is a member of the TWT TP and has Low Latency (L.L.) traffic to transmit, STA upon waking up for the enhanced TWT SP, does not set its network allocation vector (NAV). During this first Enhanced TWT SP 121, AP 102 and STA1 104 exchange low latency traffic such as low latency downlink (L.L. DL) signal 123 and low latency uplink (L.L. UL) signal 125, respectively.

STA1 104 may go to sleep after the end of the first Enhanced TWT SP 121. According to the TWT Wake Interval 130 specified either in the negotiation phase or the Beacon frame 119, STA1 104 may wake up for the next Broadcast TWT1 SP 129. During this second Enhanced TWT SP 129, AP 102 and STA1 104 transmit a L.L. DL PPDU 133 and a L.L. UL PPDU 135 respectively.

On the other hand, any third party STAs such as STA2 106, which has not negotiated membership with AP 102 and thus is not a member of the Enhanced TWT SP, is not allowed to access channel during the Enhanced TWT SPs 121, 129, as illustrated by dashed line boxes 126, 136. This may be achieved by STA2, upon waking up for the enhanced TWT SPs 121 and 129, checking if it is a member of the enhanced TWT SP; and since it is not, setting its NAV for the duration of the TWT SPs. Enhanced TWP SPs may also be known as Restricted TWT SPs since transmission of traffic types of Traffic IDs (TID) other than the ones allowed by the TWT SPs are restricted during the TWT SPs. In order to further restrict legacy STAs from transmitting during the Enhanced TWT SPs, the AP may further transmit Quiet element/Quiet Channel element to schedule quiet intervals that overlap with the Enhanced TWT SPs. For a non-AP legacy STA, control of the channel is lost at the start of a quiet interval, and the NAV is set by all of the non-AP legacy STAs in the BSS for the length of the quiet interval established by a Quiet element/Quiet Channel element, thereby restricting the non-AP legacy STAs from transmitting during the Enhanced SPs.

However, protection from overlapping BSS (OBSS) traffic, wherein a neighboring BSS is operating in a same channel, was not considered.

Multi-AP Coordinated transmission schemes, and Shared TXOP based schemes in particular, require target STAs of different BSSs to be in active mode or awake state at the same time. This may not always be possible especially when STAs operate in Power Save mode. Thus, a problem is how to ensure STAs of different BSSs that are participating in coordinated transmissions are in active mode or awake state at the same time. Further, another problem to solve is how to protect Prioritized traffic within enhanced TWTs (e.g. Low latency or NSEP traffic) by restricting the channel access (from non-designated traffic) from OBSS.

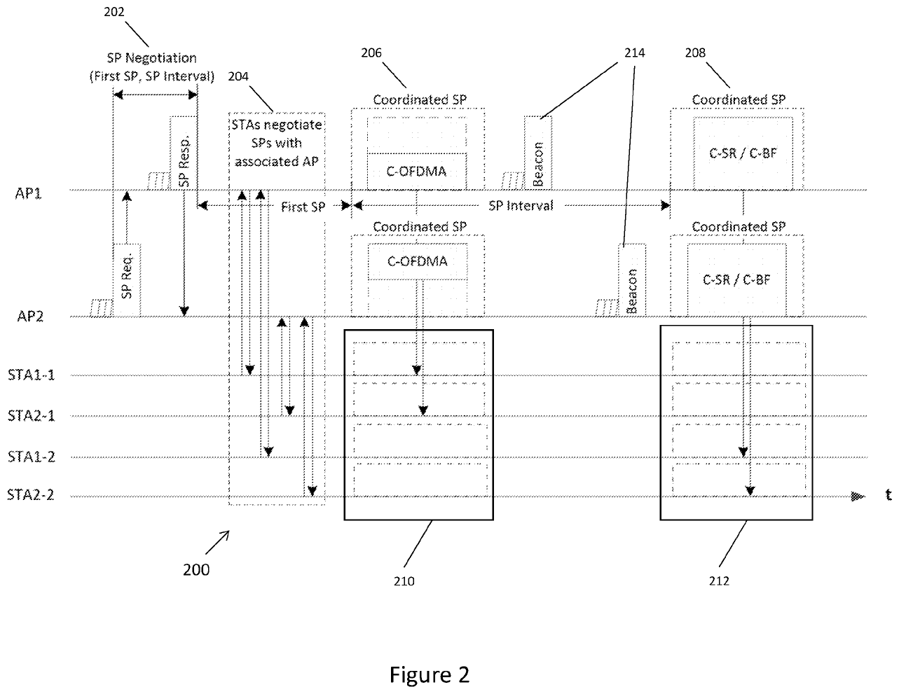

Referring to FIG. 2, APs may negotiate time periods (Coordinated Service Periods) during which they agree to perform Multi-AP Coordinated transmissions. For example, coordinated SP negotiation between AP1 and AP2 occurs at SP negotiation 202. Such coordinated SPs for Multi-AP coordinated transmissions may include periodically repeating SPs such as Coordinated SP 206 and Coordinated SP 208, wherein a Sharing AP (the AP that wins the Shared TXOP) decides the actual Multi-AP Coordinated scheme to be used within each Coordinated SP. Each AP decides the target STA/s from its associated STA/s for transmission during a Coordinated SP based on the actual Multi-AP Coordinated scheme to be used within each Coordinated SP.

At 204, STAs negotiate Scheduled SPs (BSS specific) with associated APs, or in some cases the STAs may already have negotiated the Scheduled SPs with its associated APs prior to the SP negotiation 202. For example, STAT-1 and STA1-2 negotiate with AP1 while STA2-1 and STA2-2 negotiate with AP2. The APs assign STAs to Scheduled SPs 210 and 212 such that the STAs' Scheduled SPs overlap with the Coordinated SPs, ensuring that the STAs are awake during each coordinated transmission. APs may also exchange next TBTT and Beacon Interval information 214 to ensure that the coordinated SPs do not overlap the TBTTs of the APs.

Scheduled SPs as used here denotes SPs that exist between an STA and its associated AP and may be any SP where the STAs and associated AP pre-negotiate one or more time periods to exchange frames. The STAs are expected to be in awake state or in active mode during the SP, e.g. S-APSD (Scheduled Automatic Power Save Delivery) SP, Scheduled PSMP (Power save multi-poll) SP, TWT (Target Wake Time) SP, QTP (Quiet Time Period) SP etc. The negotiations for Coordinated Service Periods may be performed between two APs at a time, but if a static Sharing AP/Shared AP hierarchy exists, many shared APs may negotiate coordinated SPs with the same Sharing AP and multiple shared APs may be assigned to the same Coordinated SP (by the Sharing AP). Otherwise, each Coordinated SP may be just between the two APs. Sharing AP refers to an AP that shares its Transmit Opportunity (TXOP) with another AP (shared AP).

APs can negotiate the following parameters for the Coordinated SPs:
Starting Time of the first SP: Time at which the first coordinated SP occurs
SP Duration: duration of each Coordinated SP
SP Interval: time interval between two consecutive Coordinated SPs
Number of Coordinated SPs: If greater than one, this parameter indicates the total number of periodically repeating Coordinated SPs. This parameter may be absent, if the Coordinated SPs are persistent and occur periodically for the entire lifetime of the Multi-AP Coordination or unless the Coordinated SPs are explicitly terminated (for example.
Characteristics of traffic that is expected to be exchanged during the SPs (data rate, burst size, delay bound etc.) may be optionally included in the setup frames.

APs may also request for specific sub portions of the SP to be allocated to itself, or also may also exchange information about each other's timing synchronization function (TSF), next TBTT, Beacon Interval (BI) to ensure that the Coordinated SPs do not overlap the Beacon transmission time of any of the APs. Once the Coordinated SPs are negotiated between the APs, within each BSS, selected STAs (i.e. vulnerable STAs that are expected to participate in coordinated transmissions) are assigned to Scheduled SPs (e.g. S-APSD SP, TWT SP etc.) that overlap with the Coordinated SPs. STAs need not be aware of the Coordinated SPs. Advantageously, knowledge of the Coordinated SPs as well as the identity of STAs participating in coordinated transmissions allows APs to better manage their schedules.

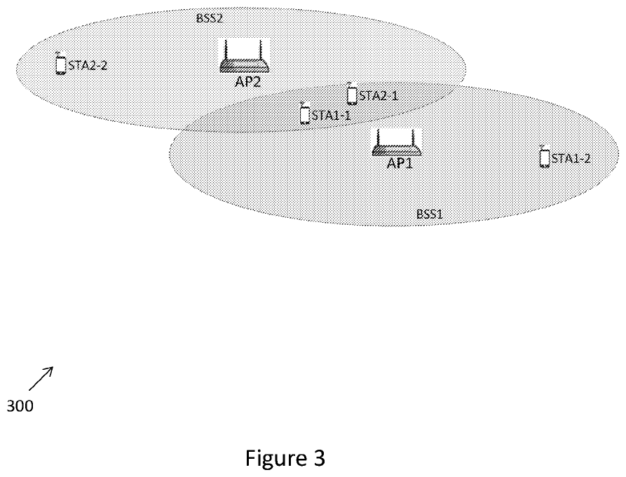

Not all STAs benefit equally from coordinated transmissions. Some may benefit more than others and these STAs may be known as Vulnerable STAs. Which STAs benefit the most also depends on the Multi-AP Coordination scheme. STAs that may benefit the most from Coordinated OFDMA should be identified prior to the coordinated transmissions, i.e. STAs within the transmission range of multiple APs for C-OFDMA/C-TDMA, or STAs that are further away from each other for C-SR/C-BF. For example, referring to FIG. 3, STA2-1 and STA2-2 are associated with AP2 (BSS2), while STA1-1 and STA1-2 are associated with AP1 (BSS1). STAT-2 and STA2-2 may benefit the most from C-SR/C-BF since they are far away from each other and simultaneous transmissions to both will not cause high interference to each other; while STA1-1 and STA2-1 benefit the most from C-OFDMA/TDMA since the two STAs are very close to each other and hence transmissions for the two must not overlap in frequency and/or time domain to avoid mutual interference.

An AP may collect reports (e.g. interference measurement reports) from associated STAs to identify the Vulnerable STAs. Typically, STAs operate in Power Save mode to save power, with each STA deciding its own awake periods (duty cycle). It is desirable that the awake states of such STAs can be synchronized among OBSSs.

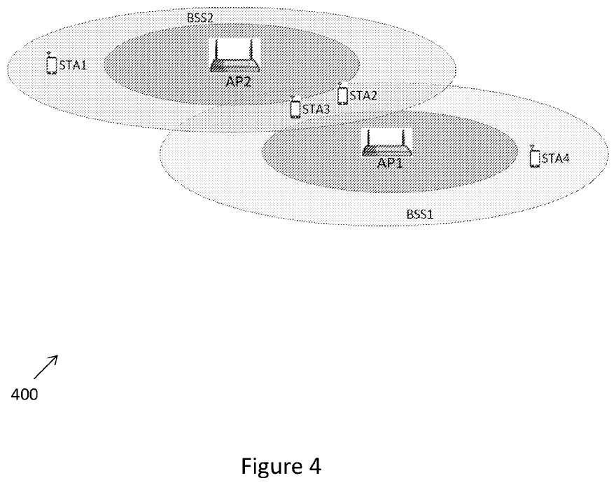

Not all cell-edge STAs may be equally affected by OBSS interference. In rare instances, even cell-center STAs may experience heavy interference from OBSS. An AP can attempt to protect the Vulnerable STAs in its BSS from OBSS interference by “reserving” frequency units (RUs) for such STAs and making such RUs known to OBSS APs. If all OBSS APs coordinate their transmissions such that they do not simultaneously transmit on the reserved RUs of their neighboring APs, interference to Vulnerable STAs can be avoided to a large extend. An AP only “reserves” RUs for STAs that need protection from OBSS, such as for Vulnerable STAs. The RU sub-set may be known as “Reserved RU set” or “Protected RU set”. The AP may use reports from its associated STAs to identify the affected STAs and also to decide the RUs for the “Reserved RU Set”. For example, referring to FIG. 4, AP2 may use a bandwidth query report (BQR), or an Interference Report from the STAs to identify STA3 as a “Vulnerable STA” and also to select the Reserved RU Set for it. There may be no restrictions in RU selection for rest of the STAs, such as STA1 of FIG. 4. The Interference Report from STAs may also identify the interfering OBSS STAs, i.e. STA2 may be identified by STA3 as an interfering STA. STA2 and STA3 may therefore be identified as the Vulnerable STAs. The AP advertises the Reserved RU Set to other APs (either by broadcasting in Beacons or over AP-to-AP links). Optionally, the AP may also report the interfering OBSS STAs.

A coordinating AP also considers the Reserved RU set of neighboring BSSs when choosing its own Reserved RU set. The Reserved RU set is chosen with minimal overlap with neighboring BSSs' Reserved RU sets. RUs for those STAs reported as interfering STAs are also restricted to the Reserved RU set.

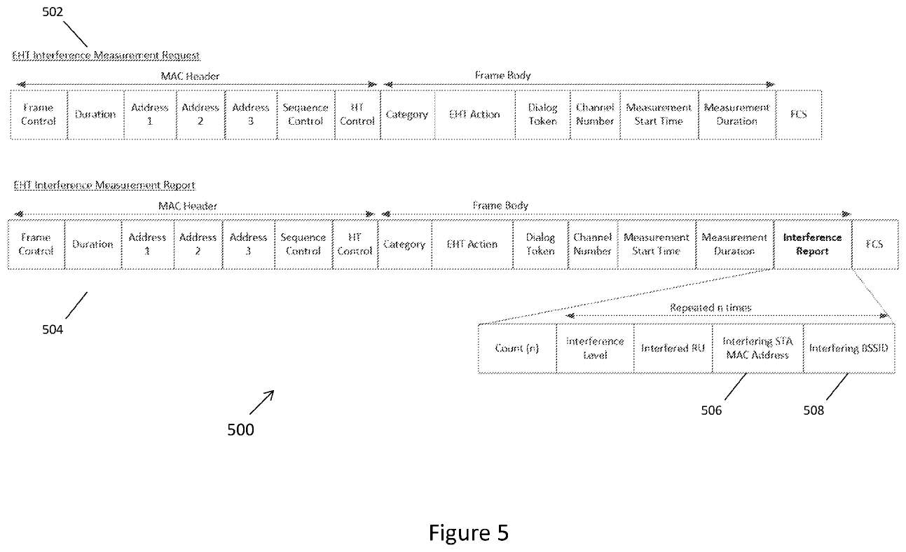

EHT Action frames may be defined to request (by an AP) and to report (by a STA) interference measurements. Referring to FIG. 5, EHT Interference Measurement Request frame 502 may be utilized by an AP for requesting interference measurements and EHT Interference Measurement Report frame 504 may be utilized by a STA for reporting interference measurements. Interfering STA MAC Address subfield 506 may indicate a STA MAC address that is extracted from a TA (transmitter address) field of an interfering frame if interference was from UL from a non-AP STA, or a STA MAC address that is extracted from a RA (receiver address) field of an interfering frame if interference was from DL to a non-AP STA. Interfering BSSID subfield 508 may indicate a BSSID that is extracted from a BSSID field of an interfering frame (usually Address field 3).

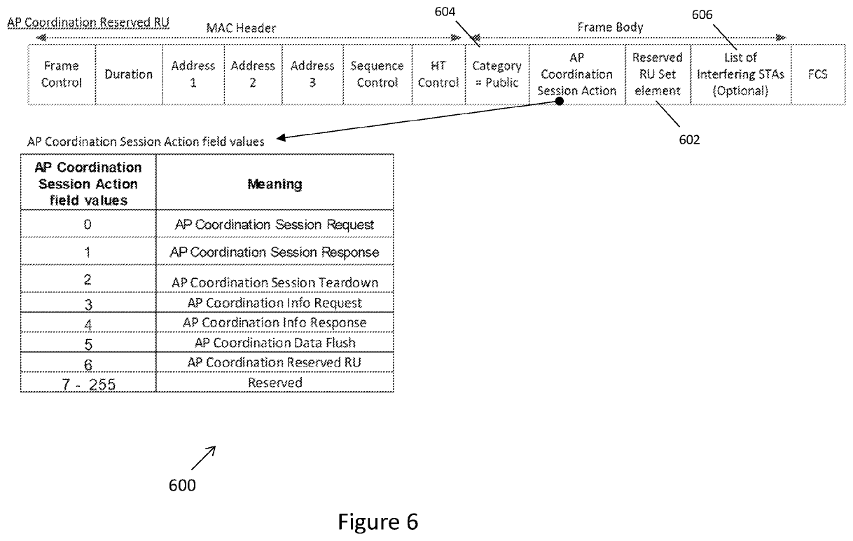

Instead of broadcasting, an AP may transmit a consolidated Cell-edge RU set or a Reserved RU Set to another AP over an AP-to-AP link, either directly as an Action frame or encapsulated in Data frames (e.g. as an Ethertype 89-0d frame)). A new AP Coordination Session Action frame 600 as shown in FIG. 6 may be defined that carries a Reserved RU set element field 602 (Same format as a Cell-edge RU Set element, except that the cell-edge RU set field renamed as Reserved RU set field). Category field 604 may have an AP Coordination Session Action field value of 6 which indicates that the AP Coordination Session Action frame 600 is for AP Coordination Reserved RU. Further, a List of Interfering STAs field 506 may list the Interfering STAs that belong to the Target AP's BSS, MAC address or association identifiers (AIDs). The information of Reserved RUs is deemed to be valid till a next “AP Coordination Reserved RU” frame is transmitted. The AP may proactively transmit the Reserved RU set to other APs, or the transmission may be a response to a request from another AP.

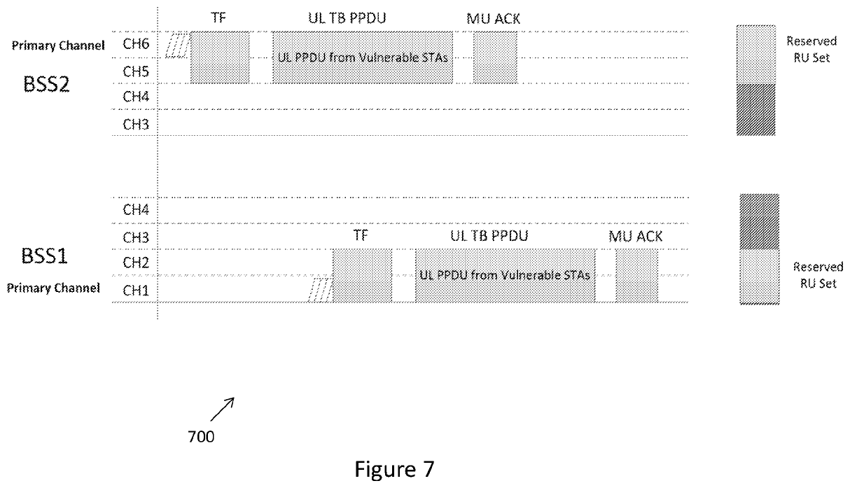

In an example of a coordinated transmission sequence as shown in FIG. 7, BSS1 and BSS2 may have different operating channels (same bandwidth but different starting frequency, different primary channels) but they overlap on CH3 and CH4. BSS1's Reserved RU sets are assigned on CH5 and CH6, while BSS2's Reserved RU sets are assigned on CH1 and CH2. There is ongoing UL MU PPDU transmission in BSS2; the RUs used for DL transmission to Vulnerable STAs are in CH5 and CH6. AP of BSS1 may solicit uplink transmission by sending TF frames assigning RUs to its Vulnerable STAs on CH1 and CH2. The Vulnerable STAs in BSS1 may then transmit their UL PPDU on the assigned RUs in CH1 and CH2. Having non-overlapping sets of Reserved RUs for Vulnerable STAs helps to minimize inter-BSS interference while promoting spatial reuse.

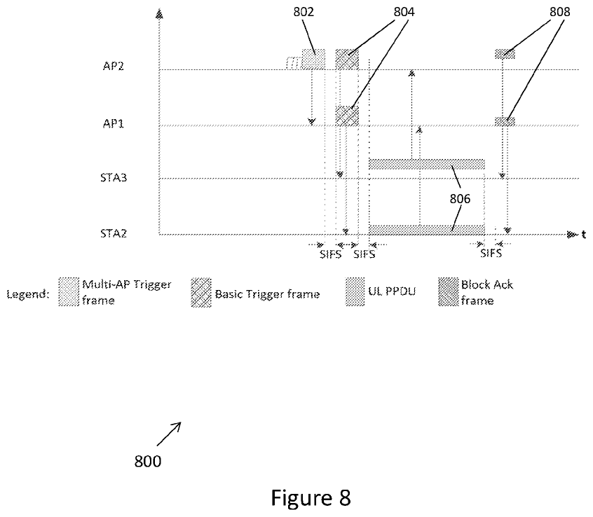

Another example of a coordinated transmission sequence is shown in FIG. 8. In Multi-AP networks in which the transmissions by multiple APs are tightly coordinated, for example, by a Multi-AP Coordinator (i.e. AP2 in FIG. 8), both the transmission timing as well as the RUs to be used for transmissions to/from Vulnerable STAs may be decided by the Multi-AP Coordinator. AP2 transmits a Multi-AP Trigger frame 802 to another AP (AP1) to initiate coordinated uplink transmissions. The Multi-AP Trigger frame 802 instructs AP1 to initiate an UL transmission from STA2 and also assigns RU1 to be used for the UL transmission from STA2.

After an interval of SIFS (Short Interframe Space), both AP2 and AP1 transmit Basic Trigger frames 804, AP2 allocating RU2 for the UL transmission from STA3, and AP1 allocating RU1 for UL transmission from STA2. After an interval of SIFS, STA3 and STA2 transmit UL PPDUs 806 on RU2 and RU1 respectively, thereby avoiding any mutual interference. AP2 and AP1 transmit Block Acks 808 on RU2 and RU1 respectively after an interval of SIFS. With this transmission sequence, APs can dynamically coordinate their RU allocations to Vulnerable STAs.

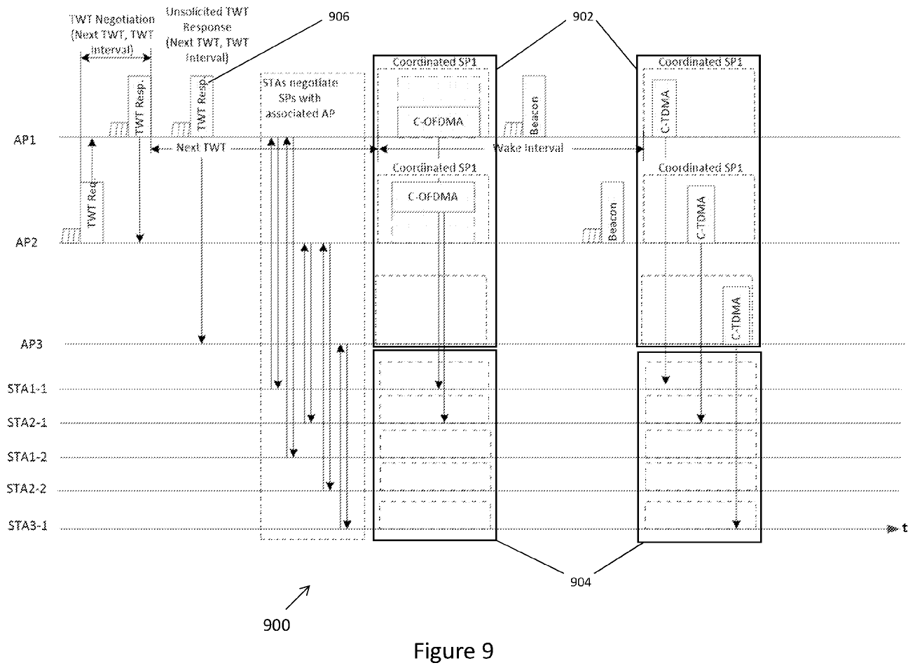

In an embodiment, individual Target Wake Time (TWT) agreement may be negotiated as Coordinated SPs between APs. A Requesting AP may act as a TWT Requester STA, and a Responding AP may act as a TWT Responder STA. Referring to FIG. 9, STA1-1 and STA1-2 are associated with AP1, STA2-1 and STA2-2 are associated with AP2, and STA3-1 is associated with AP3. Individual TWT agreements may be negotiated as Coordinated SPs 902 between the APs. The Coordinated SPs 902 may also be known as Coordinated TWT SPs. Any of the APs (i.e. AP1, AP2 or AP3) assigned to a Coordinated TWT SP may assume the role of a Sharing AP. An AP may also send an unsolicited TWT Setup Response 906 to schedule another AP to join a Coordinated SP. The AP sending the unsolicited TWT Setup Response 906 may also include a list of APs that are already/planned to be assigned to the same Coordinated SP. Once the Coordinated TWT SPs have been negotiated, each AP may negotiate or re-negotiate new/existing Scheduled SPs 904 with the Vulnerable STAs such that the Scheduled SPs 904 overlap with the Coordinated SPs 902. STAs' Scheduled SPs 904 may be any SP where the STAs and associated AP pre-negotiate one or more time periods to exchange frames and the STAs are expected to be awake state or in active mode during the SP, e.g. S-APSD (Scheduled Automatic Power Save Delivery) SP, Scheduled PSMP (Power save multi-poll) SP, TWT (Target Wake Time) SP, QTP (Quiet Time Period) SP, etc. Although in FIG. 9 it is shown that the STAs negotiate Scheduled SPs with respective associated APs at the same time, in reality, they may happen at different time and some STAs may already have negotiated Scheduled SPs even prior to the APs setting up the Coordinated SPs. Within each Coordinated SP, the Sharing AP decides the Multi-AP Coordination scheme to be used, for example, in the first Coordinated SP 902, the Sharing AP, AP1 decides to use C-OFDMA and shares the upper half of the operating bandwidth with AP2 such that AP1 and AP2 transmits to STA1-1 and STA2-1 on non-overlapping frequency channels (or RUs) during the first Coordinated SP, while AP3 does not participate in the Multi-AP Coordinated transmission. In the second Coordinated SP, the Sharing AP AP1 decides to use C-TDMA and allocates sub-section of its TXOP to AP2 and AP3 such that during the second Coordinated SP, AP1, AP2 and AP3 transmit to respective associated STAs STA1-1, STA2-1 and STA3-1 without overlapping each other's transmissions.

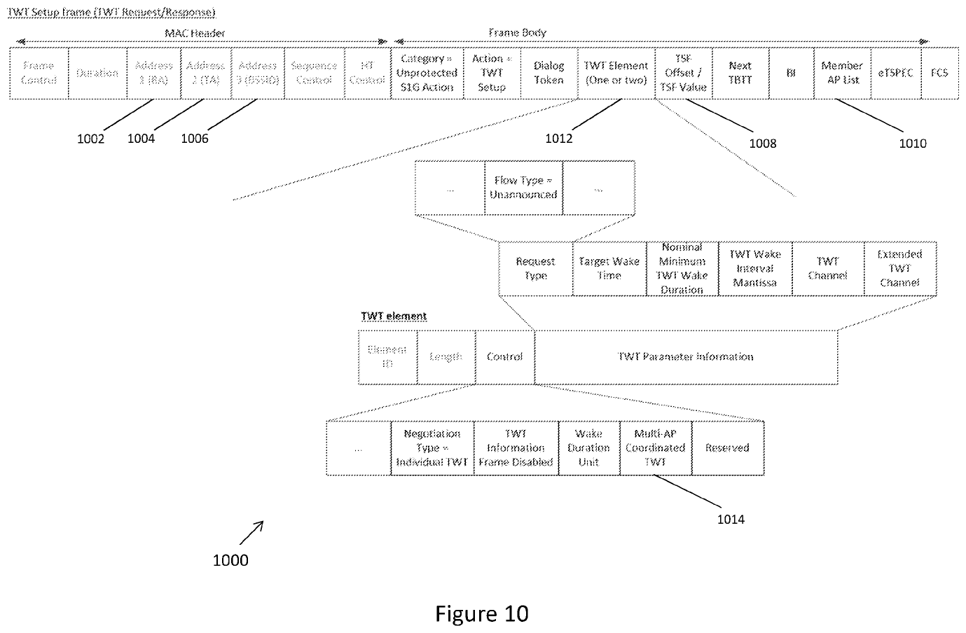

TWT Setup frames may be customized for Multi-AP Coordination. FIG. 10 shows an example of a TWT Setup frame 1000 for TWT Request/Response that are used to setup coordinated SPs. Address 1 field (or A1 field) 1002 may indicate a MAC address of a target AP. Address 2 field (or A2 field) 1004 may indicate a MAC address of a requesting AP. Address 3 field (or A3 field) 1006 may be set to a special value if one exists (i.e. virtual-BSSID for the AP Candidate Set), otherwise it is set to a MAC Address of the target AP. Since TWT Setup frames are not public action frames, by default an AP will reject such frames from STAs that are not associated with the AP. As such, the A3 field 1006 may be set to a special value (i.e. a virtual BSSID) that is known to all the APs in the AP candidate Set. TWT Setup frames with the A3 field set as the special value will be accepted by the APs in the AP candidate set. The AP may still do further filtering based on the TA, for example if an AP Candidate Set exist, it may only accept frames from the other APs in the set. Alternatively, the BS SID may be set to the receiving AP's BSSID and the receiving AP will accept the frame if the TA matches the MAC address of any of the APs in the AP Candidate Set. An AP candidate Set is a set of APs that have performed basic negotiation and capabilities exchanges and agreed to participate in Multi-AP coordinated transmissions, either as a Sharing AP (AP that shares an obtained TXOP with another AP) or a Shared AP (recipient of a shared TXOP). For this disclosure, it is assumed that all the participating APs are members of the AP candidate set. The APs are assumed to have completed the negotiation for the formation of the AP Candidate Set.

Since the Timing Synchronization Functions (TSF) of the APs are unlikely to be synchronized, in order to help the Responding AP calculate the requested Target Wake Time correctly, TSF Offset/TSF Value field 1008 may indicate either the difference between the TSFs of the two concerned Requesting and Receiving APs, or the value of the Requesting AP's TSF at the time of transmission. The APs also factor in each other's TBTT and BI when deciding the actual start times/duration of the Coordinated SPs. Member AP List field 1010 in the TWT Setup Response frame may carry a list of the MAC Addresses of other APs that are also assigned to the same Coordinated TWT SP. Further, a reserved bit (Multi-AP Coordinated TWT subfield 1014) of a TWT Element 1012 may be used to highlight that TWT element field 1012 is for Coordinated SPs.

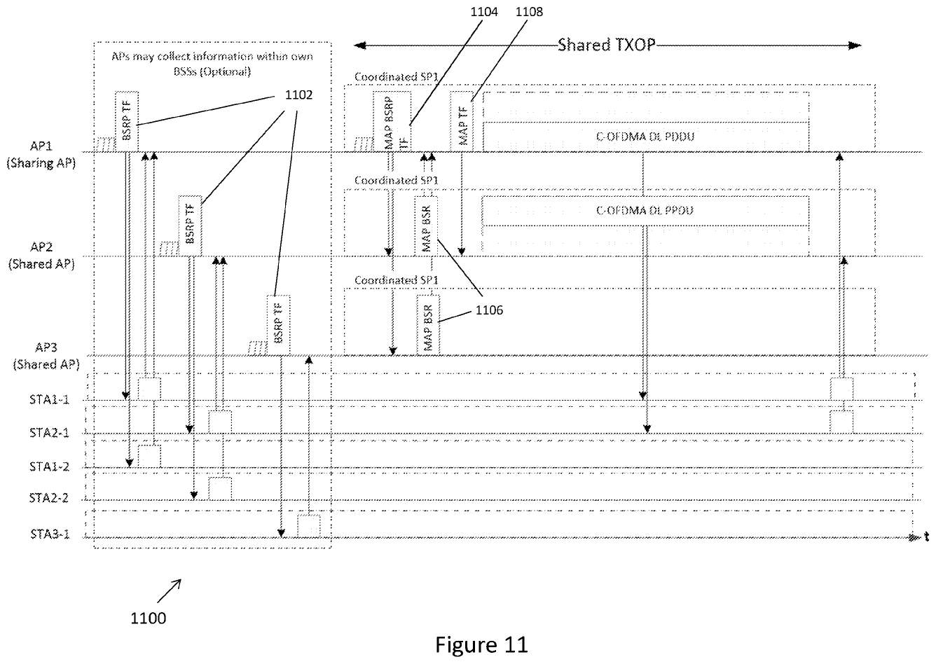

In an example transmission as illustrated in FIG. 11, scheduled SPs for STAs may also be TWT for example, Triggered TWT SPs. The STA's scheduled SPs may start a bit earlier than the Coordinated SP to allow APs to check if they are awake, their Buffer status, etc. Shared APs can pass this information to the Sharing AP (e.g. at the start of the Shared TXOP), and the Sharing AP may use this information to decide which Shared AP/s to share the TXOP with. For example, at the start of the scheduled SPs, each AP i.e. AP1, AP2 and AP3 may optionally collect information of their associated STAs within their own BSSs by transmitting a Buffer Status Report Poll Trigger frame (BSRP TF) 1102 to each associated STA, to which each STA responds by transmitting the requested information to the associated STA. Sharing AP1 may then transmit, for example at the start of a Coordinated SP1, a MAP Buffer Status Report Poll Trigger frame (BSRP TF) 1104 to Shared APs AP2 and AP3 to request for the information of their associated STAs. AP2 and AP3 may each then transmit a MAP BSR frame 1106 to AP1 in OFDMA manner to report the buffer status (both UL and DL) for their identified or associated STAs. For example, based on the report, AP3's buffered traffic is much less than that of AP2, so AP1 decides to share the TXOP with AP2, and thus transmits a MAP TF 1108 to AP2 to indicate AP1's intention to share the TXOP with AP2 and the related transmission parameters such as the RU assigned to AP2, transmission duration, MCS, TX power etc. SIFS after the MAP TF 1108, AP1 and AP2 commence the coordinated transmission, each transmitting a DL PPDU to STA1-1 and STA2-2 respectively in OFDMA manner, followed by each STA transmitting back an acknowledgement frame (e.g. a BlockAck frame) to the associated AP. The MAP BSR frame 1106 also serves the purpose of protecting the Coordinated Transmission by setting the NAVs of all the STAs within transmission range of AP1.

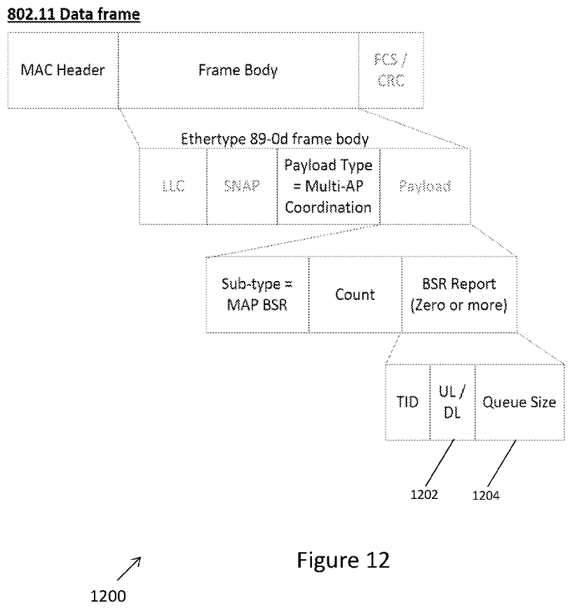

An Ethertype 89-0d Data frame such as data frame 1200 in FIG. 12 may be used as a MAP-BSR frame (such as MAP BSR frame 1106) to share the Buffer Status Report between APs. For example, UL/DL field 1202 may indicate whether the report is for DL or UL buffer. Queue Size field 1204 may indicate the estimation of the total buffer size at the AP (for DL)/associated Vulnerable STAs (for UL) (same encoding as in 11ax may be used).

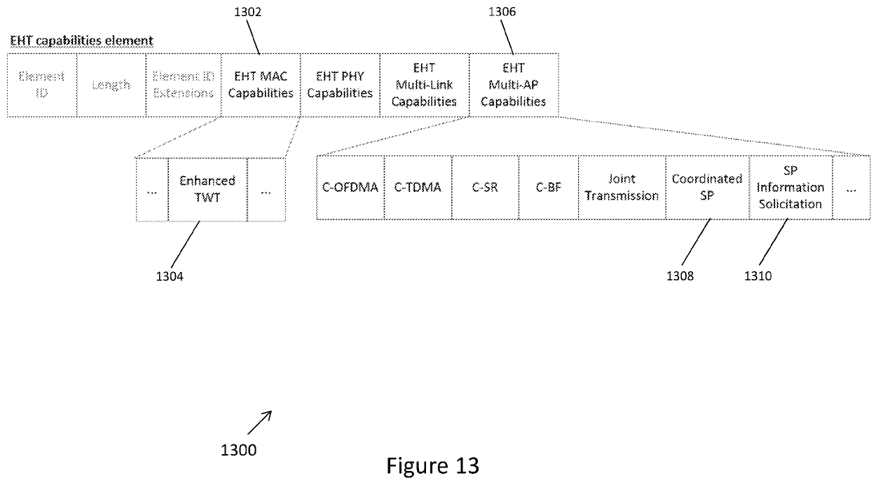

Further, an AP or STA may indicate their supported features using an EHT capabilities element 1300 as shown in FIG. 13. For example, EHT MAC Capabilities field 1302 may include an Enhanced TWT field 1304 which may indicate whether Enhanced TWT is supported. EHT Multi-AP Capabilities field 1306 may include a C-OFDMA field, C-TDMA field, C-SR field, C-BF field and Joint Transmission field which may be used to indicate if a Multi-AP transmission scheme is supported. The EHT Multi-AP Capabilities field 1306 may also include a Coordinated SP field 1308 which may indicate whether a concerned AP supports Coordinated SPs, and a SP Information Solicitation field 1310 which may indicate whether a concerned AP supports solicitation of information about SPs.

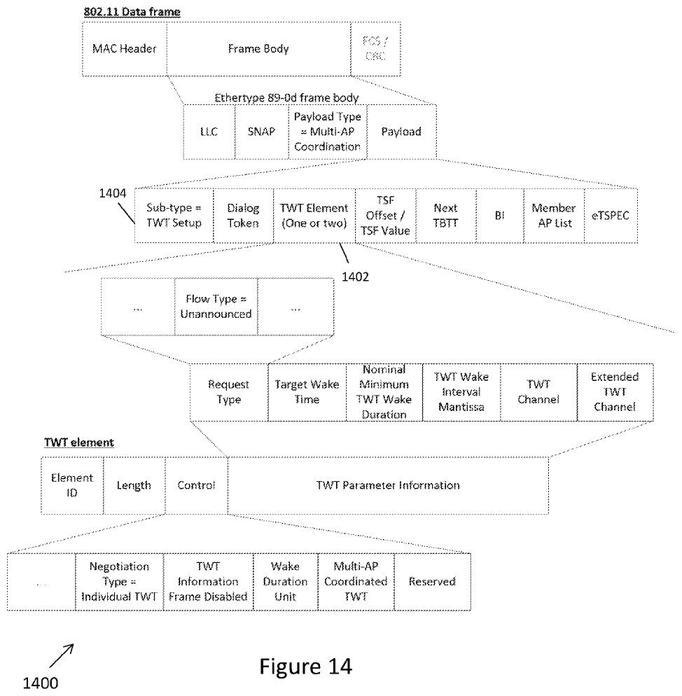

TWT Setup frames (to setup coordinated SPs) may also be carried within Ethertype 89-0d Data frames, such as 802.11 data frame 1400 of FIG. 14. For example, the data frame 1400 may include one or more TWT Element fields 1402 that comprises information for setting up coordinated SPs, as well as sub-type field 1404 indicating that data frame 1400 is for TWT Setup.

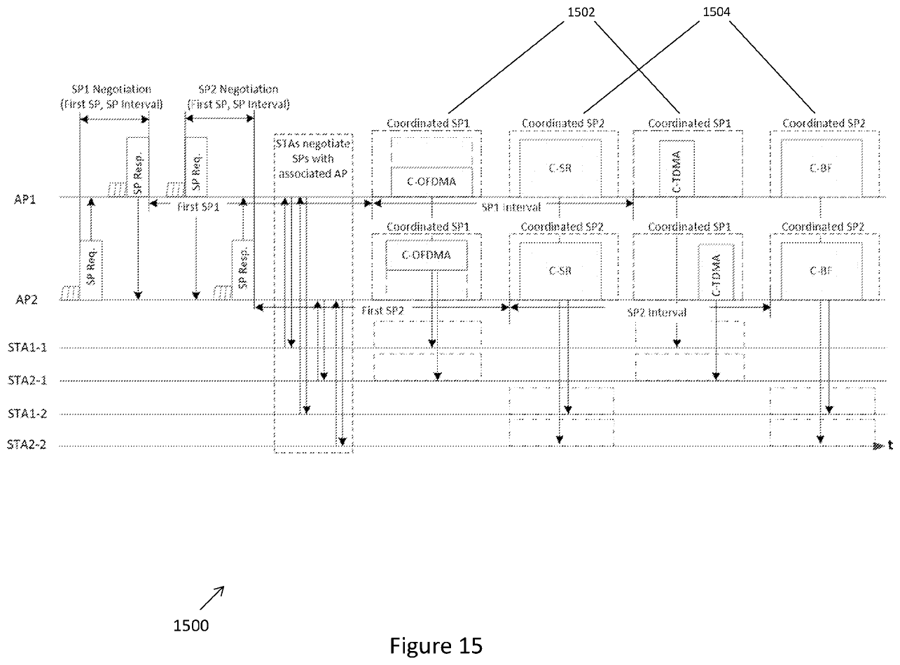

In various embodiments, a Coordinated SP may specify the Multi-AP Coordination schemes (C-OFDMA/C-TDMA, C-SR/C-BF, Joint Transmission etc.) or the allowed traffic type within the SP. For example, referring to FIG. 15, Coordinated SP1 1502 may be Coordinated SPs for C-OFDMA/TDMA transmissions, while Coordinated SP2 1504 may be Coordinated SPs for C-SR/C-BF transmissions. STAs may then be assigned to Scheduled SPs (BSS specific) that lie within the Coordinated SPs that are suitable for them, ensuring that they are awake during suitable coordinated transmissions. This advantageously enables the STAs to have more power saving gains and avoid unnecessarily waking up during unsuitable Coordinated SPs.

An AP may request another AP to setup Coordinated SP for a particular type of MAP Coordination scheme, or for Coordinated SP for a particular type of traffic. During the SP negotiation phase, the requesting AP may also specify the desired 20 MHz sub-channels for itself for C-OFDMA; the Responding AP may specify the assigned 20 MHz sub-channels for requesting AP for C-OFDMA. Similarly the requesting AP may also specify the desired sub-time slots within the SP for itself for C-TDMA, or for prioritized traffic; the Responding AP may specify the assigned sub-time slots for the requesting AP. APs may further protect the sensitive traffics (e.g. low latency/NSEP traffic) during the sub-time-slots from each AP's own associated STAs by transmitting Quiet Element/s or Quiet Channel Element/s in Beacon/Probe Response frames such that the BSS channels are quieted during the sub-time-slots.

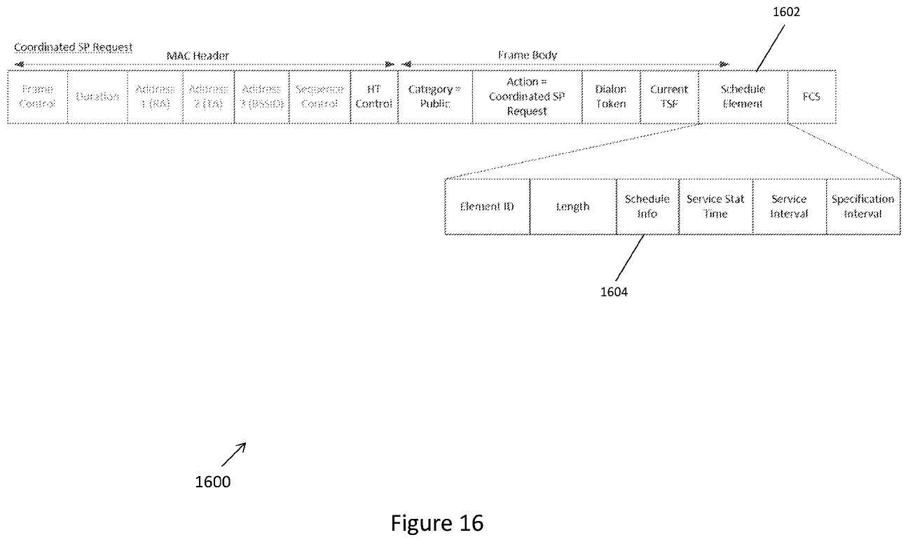

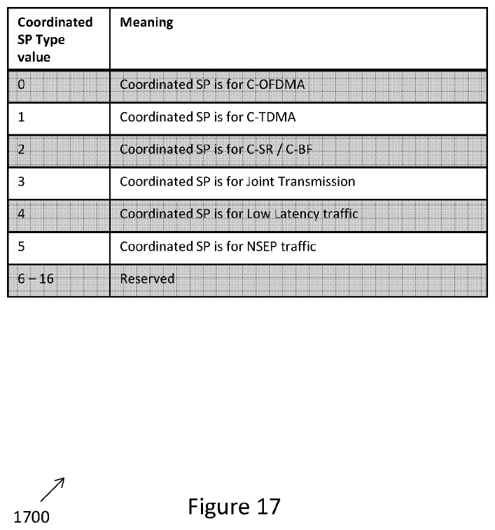

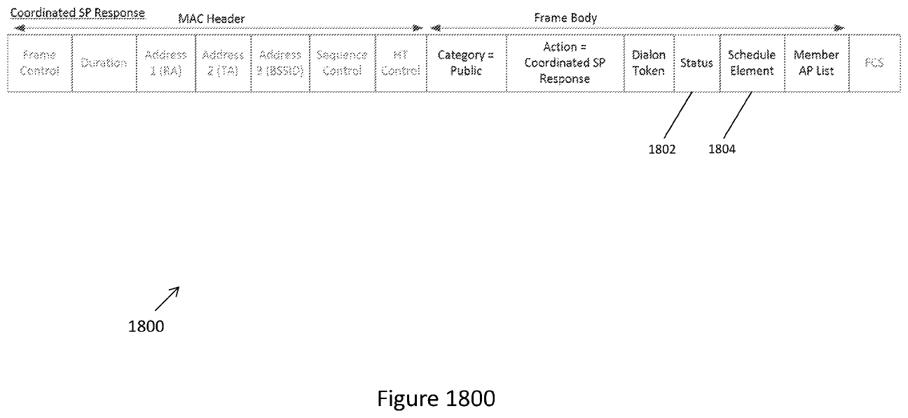

New Public Action frames, such as Coordinated SP Request Action frame 1600 of FIG. 16 and Coordinated SP Response Action frame 1800 of FIG. 18, may be used to negotiate the Coordinated SPs. For example, Coordinated SP Request frame 1600 may include a Schedule Element field 1602 that may indicate the requested SP parameters. The Schedule Element field 1602 may also include a Schedule Info field 1604 that may indicate a Coordinated SP Type value with reference to Table 1700 of FIG. 17. For example, a Coordinated SP Type value of 0 indicates that the Coordinated SP is for C-OFDMA, a Coordinated SP Type value of 1 indicates that the Coordinated SP is for C-TDMA, and so on. Further, Coordinated SP Response frame 1800 may include a Status field 1802 that may indicate whether the request was accepted or rejected. The frame may also include a Schedule Element field 1804 that may indicate the agreed SP parameters for the Coordinated SP.

In an example, Baseline Schedule element may be reused (9.4.2.33 Schedule element of IEEE 802.11-2020) to negotiate Coordinated SPs. For example, the Service Start Time field of the Baseline Schedule element indicates the anticipated time, expressed in microseconds, when service starts and represents the lower order 4 octets of the TSF timer value at the start of the first SP. The Service Interval field indicates the time, expressed in microseconds, between two successive SPs and represents the measured time from the start of one SP to the start of the next SP. Further, some reserved bits in the Schedule Info field may be used to indicate the Coordinated SP Type information i.e. the Multi-AP Coordination scheme that will be performed within the Coordinated SP. The Specification Interval field may be repurposed to signal the Number of Coordinated SPs for periodically repeating Coordinated SPs.

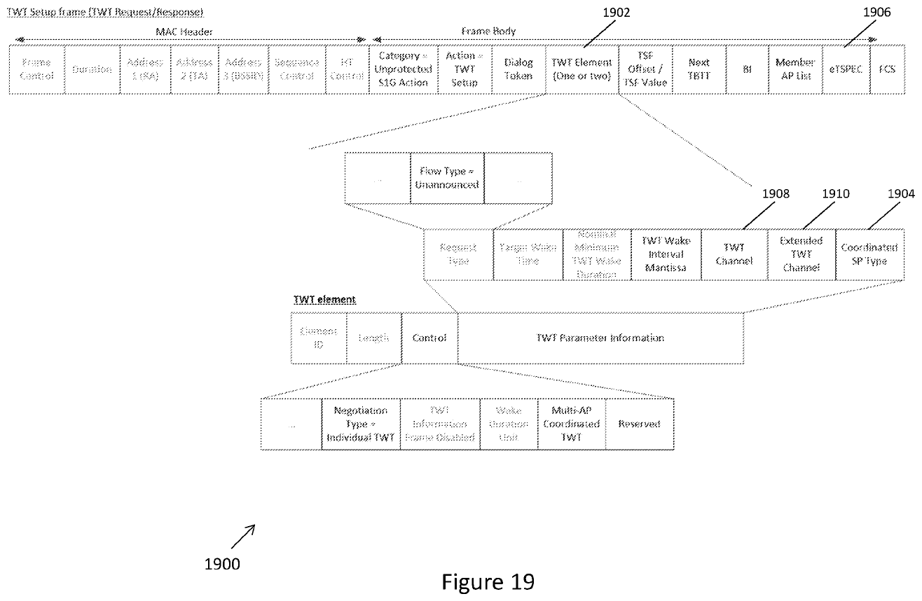

Alternatively, TWT Setup frames may be used to negotiate the Coordinated SPs. Referring to an example TWT Setup frame 1900 of FIG. 19 that may be utilized for TWT Request and Response to setup Multi-AP Coordinated TWT SPs, TWT Setup frame 1900 may include one or more TWT Element fields 1902 which include a Coordinated SP Type field 1904 for specifying the Multi-AP Coordination scheme and/or allowed traffic type. For example, Coordinated SP Type field 1904 may indicate a Coordinated SP Type value based on Table 1700 of FIG. 17 to indicate the Coordinated SP Type. TWT Setup frame 1900 may also include an eTSPEC field 1906 that may indicate traffic characteristics. For example, if the Coordinated SP Type field 1904 indicates a certain traffic type, further characteristics of the traffic may be indicated in the eTSPEC field 1906.

For intra-BSS TWT negotiations, the TWT Channel field (such as TWT Channel field 1908) and the Extended TWT Channel fields (such as Extended TWT Channel field 1910) in TWT Element in the TWT Setup frames are together used for HE/EHT Subchannel selective transmissions. The TWT Channel may be used to signal the secondary channel/s requested for HE/EHT STAs within the primary 160 MHz. The Extended TWT Channel may be used to signal the secondary channel/s requested for EHT STAs in the secondary 160 MHz. 1 bit set to 1 indicates a 20 MHz channel for a 20 MHz operating STA, while the 4 least significant bits (LSBs) or 4 most significant bits (MSBs) all set to 1 indicate the first or the second 80 MHz channel within the secondary 160 MHz.

In TWT negotiations for C-OFDMA MAP Coordinated SP, the TWT Channel field and the Extended TWT Channel fields in TWT Element in the TWT Setup frames are together used to signal the desired/assigned sub-channels for the requesting AP during C-OFDMA MAP transmissions. The TWT Channel is used to signal the secondary channel/s requested for the AP within the primary 160 MHz, each bit representing one 20 MHz sub-channel. The Extended TWT Channel is used to signal the secondary channel/s requested the AP in the secondary 160 MHz, each bit representing one 20 MHz sub-channel.

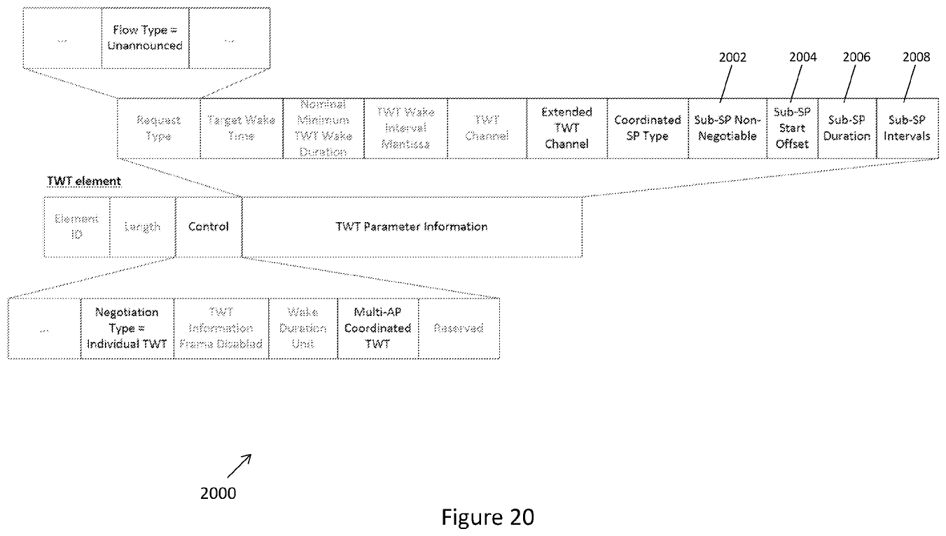

An AP may also request for Sub-SP (i.e. a specific time-slot) within a Coordinated SP. The Sub-SP may indicate a smaller period of time during which the requesting AP has a need for quasi-guaranteed channel access (for example for low latency traffic that is highly sensitive to jitters). Referring to FIG. 20, in TWT negotiations for C-TDMA MAP Coordinated SP or for Coordinated SPs for Prioritized traffic, the TWT Setup frames i.e. such as TWT Element 2000 of FIG. 20 may also carry the information related to the desired/assigned sub-SP (within the Coordinated SP) for the requesting AP during C-OFDMA MAP transmissions:
If set, Sub-SP Non-Negotiable field 2002 indicates that the requested Sub-SP start time cannot be changed.
Sub-SP Start Offset field 2004 is used to signal the time offset from the SP Start time till the start of the requested/assigned Sub-SP.
Sub-SP Duration field 2006 is used to signal the duration of the requested/assigned sub-SP.
Sub-SP Intervals field 2008 indicates the time interval between consecutive Sub-SPs if the Sub-SP are also periodic.

If 11be decides not to allow mixing of C-OFDMA and C-TDMA transmission within the same MAP Shared TXOP, it is also possible that the TWT Channel and the Extended TWT Channel fields are repurposed as the Sub-SP Start Offset field and Sub-SP Duration field when the Coordinated SP Type is C-TDMA, or if the Coordinated SP Type is reserved for Prioritized traffic.

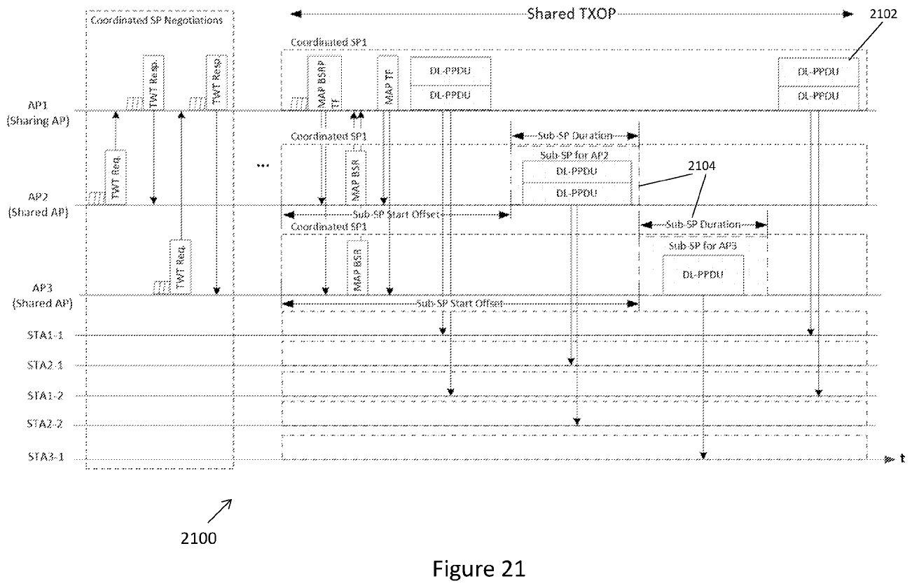

FIG. 21 illustrates example diagram 2100 of coordinated SPs for C-TDMA. In this example, all STAs have low-latency traffic and the negotiated Coordinated SP type is low latency. When negotiating the Coordinated SP with AP1, AP2 and AP3 may also indicate a sub-section of the Coordinated SP (called sub-SP, such as sub-SPs 2104) during which they have a need to provide quasi-guaranteed channel access to certain traffic types (e.g. for low latency traffic that are very sensitive to jitters). If the Sub-SPs of member APs of the Coordinated SP do not overlap, during a shared TXOP, the Sharing AP may employ C-TDMA transmissions, doing its best to provide the shared TXOP to each member AP during their requested Sub-SP. Each AP uses their allocated Sub-SP 2104 to communicate with respective associated STAs. Sharing AP AP1 may take back any unused portion of the TXOP for transmissions to its own associated STAs i.e. such as for transmissions of DL-PPDU 2102.

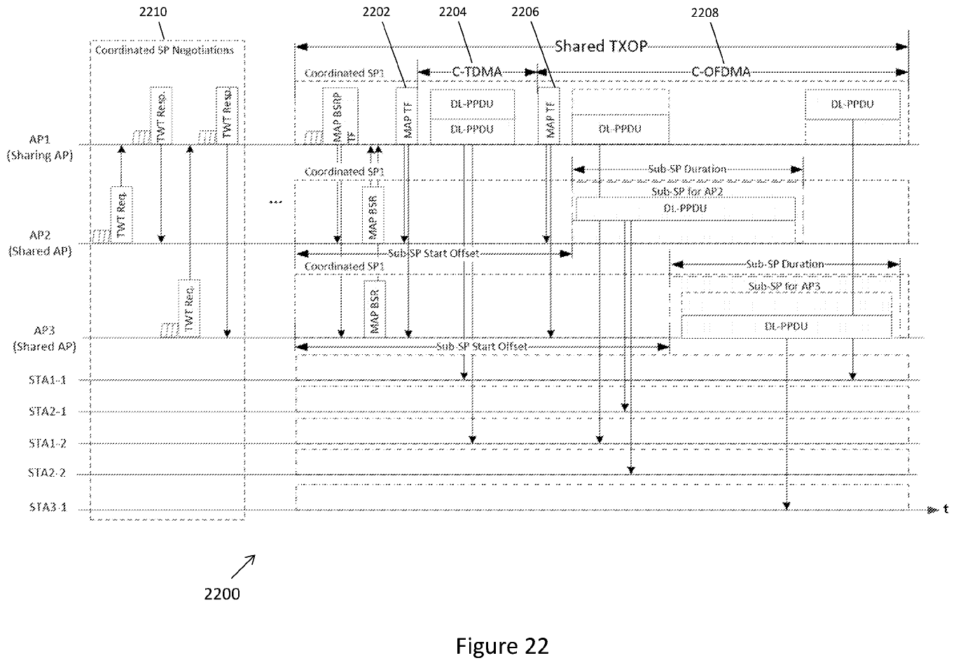

If the Sub-SPs of member APs of the Coordinated SP overlap with each other, during a shared TXOP, the Sharing AP may not be able to cleanly share the TXOP solely using C-TDMA. In such cases, the Sharing AP may employ mixed C-TDMA and C-OFDMA transmissions, doing its best to provide the shared TXOP to each member AP during their requested Sub-SP and at the same time ensuring that, at least during the Sub-SPs, the member APs are assigned different sub-channels. For example, referring to C-TDMA+C-OFDMA example diagram 2200 of FIG. 22, the Sharing AP AP1 uses the entire bandwidth during the initial portion of the Shared TXOP for transmissions to/from its own associated STAs via C-TDMA portion 2204 and assign the second portion of the Shared TXOP to other member APs of the coordinated SP. For example, the Sharing AP AP1 may transmit MAP TF 2202 to Shared APs AP2 and AP3 to signal C-TDMA parameters for the C-TDMA portion 2204. During the second portion of the TXOP, the Sharing AP may further employ C-OFDMA and share the TXOP with member APs, allocating non-overlapping sub-channels to each member AP. To achieve this, the Sharing AP may transmit a second MAP TF 2206, at the end of its own C-TDMA portion 2204 of the TXOP, to allocate sub-channels to the member APs during C-OFDMA portion 2208 of the Shared TXOP, i.e. the secondary 160 MHz channel to AP2 and the primary 160 MHz channel to AP3 (assuming the operating channel of all APs to be 320 MHz). Alternatively, if the sub-channels are already allocated during the Coordinated SP negotiation 2210 (e.g. using the TWT Channel field and TWT Extended Channel fields of the TWT element), the second MAP TF 2206 for C-OFDMA may be skipped since each AP is already aware of its allocated sub-channels. Each Shared AP, AP2 and AP3, use their allocated channels within the Sub-SPs to communicate with respective associated STAs. The Sharing AP may also opportunistically use any unused portion of the TXOP (either in time or frequency domain) for transmissions to its own associated STAs. In this example, all STAs have low-latency traffic and the negotiated Coordinated SP type is low latency.

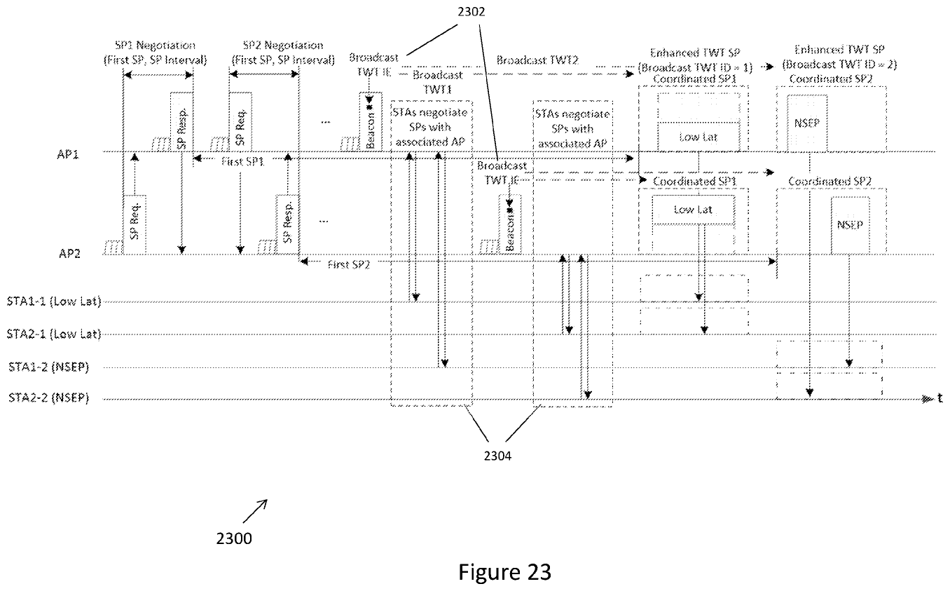

In an embodiment, each AP may also advertise the Coordinated SPs to STAs in the BSS i.e. APs may overlap broadcast TWT SPs over the coordinated SPs and advertise them via TWT elements in Beacon frames. For example, referring to transmission diagram 2300 of FIGS. 23, AP1 and AP2 may set up broadcast TWT SPs that overlap with the coordinated SPs using Beacon frames 2302, for example setting up a set of Enhanced TWT SP (broadcast TWT SPs with ID 1) to overlap with Coordinated SP1 and another set of Enhanced TWT SP (broadcast TWT SPs with ID 2) to overlap with Coordinated SP2. In this example, APs may not identify STA types, instead STAs may negotiate to join the broadcast TWT SPs of interest i.e. at transmission portion 2304. STAs need not be aware of the existence of the overlapping coordinated SPs. Thus, APs need not identify and micro-manage the STAs, since STAs can sign up for SPs of interest, for example STA1-1 and STA2-1 having low latency traffic to transmit, may negotiate to join the Enhanced TWT SP (with broadcast TWT ID 1), while STA1-2 and 2-2 having NSEP traffic to transmit may negotiate to join the Enhanced TWT SP (with broadcast TWT ID 2).

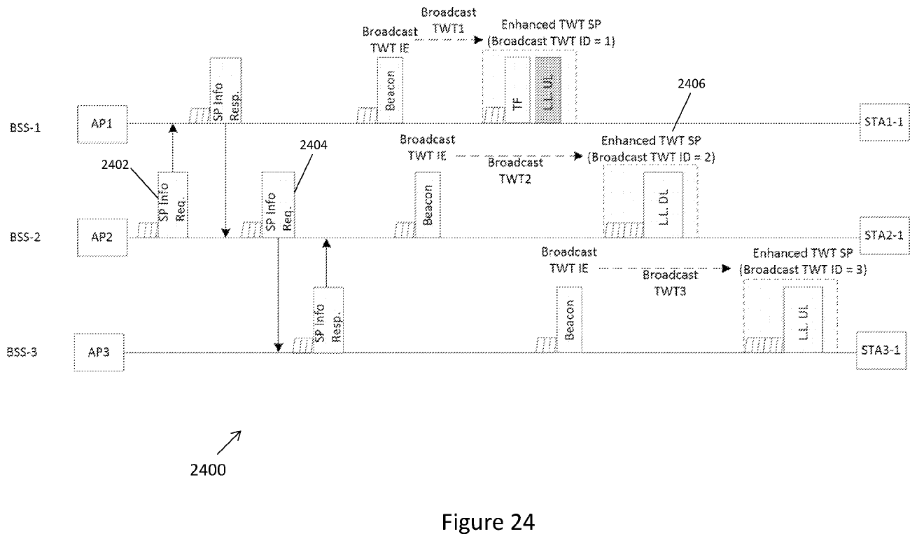

In an embodiment, an AP can request a second AP for information of the Scheduled SPs for the second AP's associated STAs and use the information to schedule the SPs for its own associated STAs to reduce mutual contention between prioritized traffic among OBSS s. Referring to transmission diagram 2400 of FIG. 24, APs of an AP Candidate Set exchange information regarding Enhanced TWT SPs (existing and/or intended) and coordinate their Enhanced TWT SPs such that the TWT SPs do not overlap in time/frequency domains. For example, AP2 may request Enhanced TWT information of AP1 and AP3 by transmitting a SP Info Request 2402 to AP1 and a SP Info Request 2404 to AP3 respectively. With the Enhanced TWT information of AP1 and AP3, AP2 can ensure that its own Enhanced TWT SPs i.e. Enhanced TWT SP 2406 do not overlap in time/frequency with AP1/AP3's Enhanced TWT SPs.

The information exchange between the APs may be over-the-air (in-band) or may be over the backhaul link (wired/wireless) (out of band). Enhanced TWT may be as defined in Singapore patent application no. 10202012139Q. While the coordination can be for any TWT SP, coordination of Enhanced TWT may bear more benefit by ensuring that the Prioritized traffics (e.g. Low Latency traffic) of OBSS do not contend for the channel at the same time. This embodiment may be suitable for deployments where there is no strong relation between APs (e.g. non-enterprise deployments) and the APs do not intend to share TXOPs.

While it is possible that an AP can decode another AP's Beacon frames to collect information of the other AP's broadcast Enhanced SP (if any) and passively adjust their own Enhanced SPs (if needed) to avoid overlaps; however individual TWT SPs are not advertised in Beacon frames and so another AP may not be aware of an AP's individual TWT SPs. An AP may also request information of another AP's Service Period (AP Coordinated SPs, or Scheduled SPs (both broadcast and individual SPs) of the AP's STAs). For example, an AP can request another AP for information of its Coordinated SPs, which it can use to request to join Coordinated SPs of interest. Alternatively, an AP can also request another AP for information of the enhanced TWT SPs for prioritized traffic and adjust its own enhanced TWT for prioritized SPs, if needed, such that the SPs of the two SPs do not overlap. In a managed network (e.g. enterprise deployment), such coordination of SPs among APs may also be centrally managed e.g. by AP Controller/s. If a Master/Slave hierarchy exist among the APs, the Master AP may help in the coordination of the SPs among APs

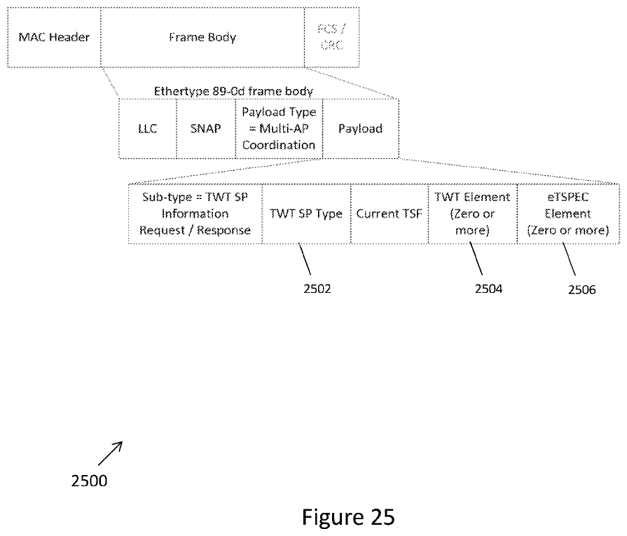

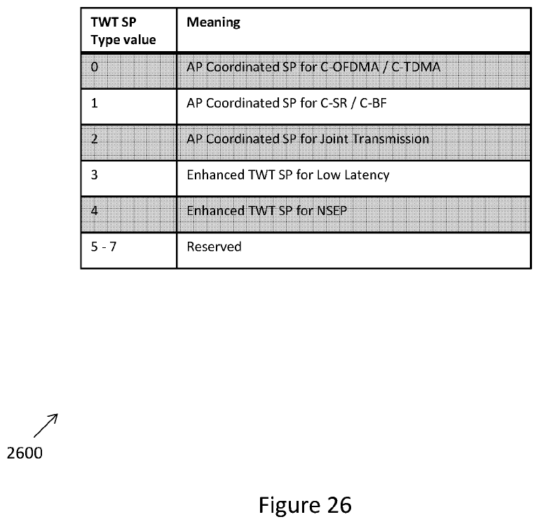

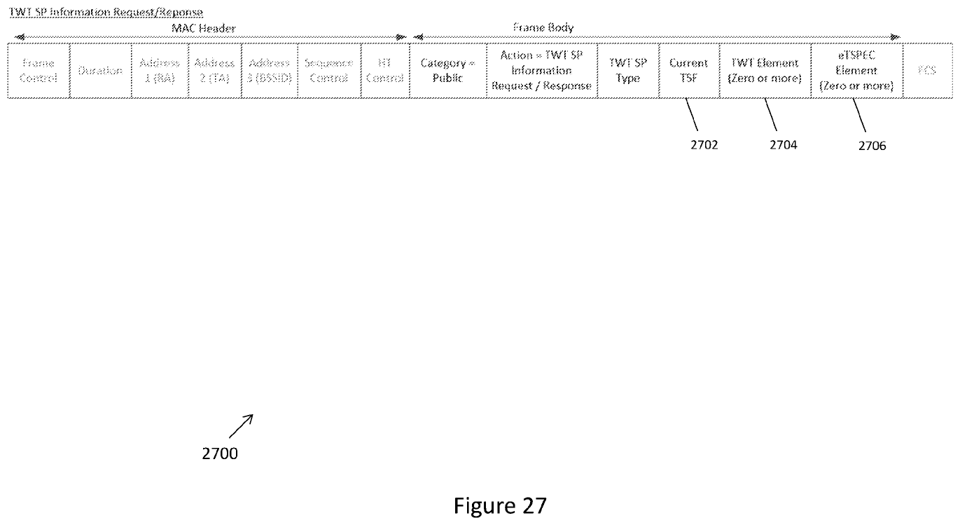

Either a data frame with “Ethertype 89-0d” frame body, such as data frame 2500 of FIG. 25, or a new Public Action frame, such as TWT SP Information Request/Response Action frame 2700 of FIG. 27, may be used to request or share information of an AP's Service Period/s with other APs. Referring to data frame 2500, TWT SP Type field may indicate a TWT SP Type value based on Table 2600 of FIG. 26. For example, a TWT SP Type value of 0 indicates that the AP Coordinated SP is for C-OFDMA/C-TDMA, a value of 1 indicates that the AP Coordinated SP is for C-SR/C-BF, and so on. The data frame 2500 may include zero or more TWT Element fields 2504 that carry information about the TWT SP, and zero or more eTSPEC Element fields 2506 that carry information about the characteristics of the traffic that is expected/allowed to be exchanged during the TWT SP.

Referring to TWT SP Information Request/Response frame 2700 of FIG. 27, the following fields are always carried in TWT SP Information Response frame and may be optionally carried in the TWT SP Information Request frame:
Current TSF field 2702: Carries the AP's TSF value at transmission time to help the receiving AP calculate the TWT SP's Target Wake Time
TWT Element field 2704: Each TWT Element carry information about one TWT SP of the transmitting AP.
   Further, the eTSPEC element field 2706, which carries information about the characteristics of the traffic that is expected/allowed to be exchanged during the TWT SP, may be optionally carried in both frames.

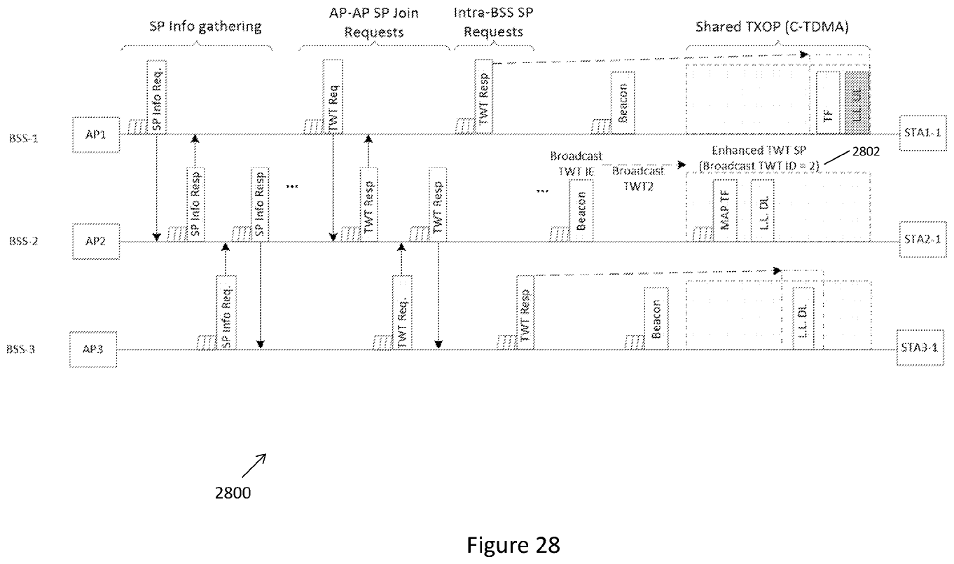

In an embodiment, an AP may also request to join another AP's existing scheduled SP (e.g. either individual or broadcast TWP SPs). Referring to transmission diagram 2800 of FIG. 28, AP2 has setup a broadcast enhanced TWT SP (ID 2) 2802 for its associated STAs (e.g. for low latency traffic). AP1 and AP3 gathers information of AP2's enhanced TWT SPs for low latency either by passively listening to AP2's Beacon frames or through exchange of SP Info Request/Response frames. AP1 and AP3 requests to join AP2's broadcast TWT SP (ID 2) 2802. During the TWT SP, AP2, knowing AP1 and AP3 are also members of the TWT SP, may share its TXOP with AP1 and AP2, e.g. for C-TDMA transmissions.

APs may also indicate desired sub-channels or sub-SP in the TWT Setup requests. In this case, the first APs requesting to join the TWT SP are the TWT Requesting STAs (or TWT Scheduled STA) while the second AP accepting the request is the TWT Responding STA (or TWT Scheduling STA). During the TWT SP, the second AP is expected to act as a Sharing AP, while the first APs will be Shared APs. The first APs should wait for the second AP to initiate coordinated transmission at the start of the TWT SP and refrain from attempting to gain access to the channel. In the example, there are four phases:
Phase 1 (SP Info gathering phase): AP1 and AP3 gathers information of the TWT SPs offered by AP2 (either broadcast/individual TWT SPs for its associated STAs, or coordinated SPs for other APs).
Phase 2 (AP-AP SP Join phase): AP1 and AP3 requests to join one of AP2's broadcast enhanced TWT SP (e.g. one that is reserved for low latency traffic). AP1 and AP2 may also request for Sub-SPs within the TWT SP.
Phase 3 (Intra-BSS SP Requests): If intra-BSS SPs do not already exist, AP1 and AP3 may setup SPs for their associated STAs that may benefit from MAP coordinated transmissions such that the SPs lie within AP2's TWT SP that AP1 and AP2 have joined. The intra-BSS SPs overlap with the Sub-SPs if any were requested by the APs. For example, this may be achieved by the APs transmitting unsolicited TWT Setup Response frames to selected STAs if a new TWT SP is to be setup, or by transmitting TWT Information frames to adjust the start time of existing TWT SP.
Phase 4 (MAP Coordinated transmissions during the TWT SP): AP2 initiates a coordinated transmission (e.g. C-TDMA/C-OFDMA etc.) during the TWT SP, for example allocating time/frequency resources for AP1 and AP3 within the shared TXOP.

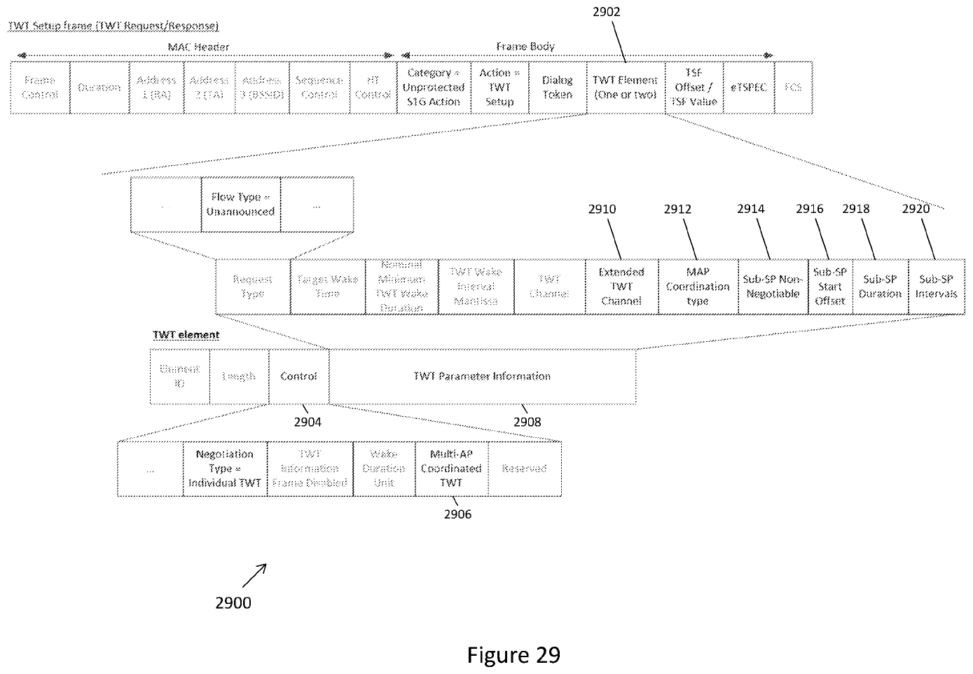

FIG. 29 illustrates a TWT Setup frame 2900 that may be utilised via individual TWT Setup to join another AP's existing TWT SP. Since TWT Setup frames are not public Action frames, special exception may be made in the IEEE 802.11be specification to allow APs to accept TWT Setup frames transmitted by another AP. Alternatively, new public Action frame equivalents of TWT Setup frames may be defined for AP to AP TWT setup. TWT Setup frame 2900 may include one or two TWT Element fields 2902 which may include Control field 2904 and a TWT Parameter Information field 2908. The Control field 2904 may include a Multi-AP Coordinated TWT field 2906 which may indicate using a reserved bit that the TWT element is for AP to AP Setups. TWT Parameter Information field 2908 may include an Extended TWT Channel field 2910 which may signal the secondary channel/s requested within the secondary 160 MHz, a MAP Coordination type field 2912 which may indicate the MAP Coordination transmission scheme that may be used during the TWT SP, a Sub-SP Non-Negotiable field 2914 which (if set) may indicate that the requested Sub-SP start time cannot be changed, a Sub-SP Start Offset field 2916 which may signal the time offset from the SP Start time till the start of the requested/assigned Sub-SP, a Sub-SP Duration field 2918 which may signal a duration of the requested or assigned sub-SP, and a Sub-SP Intervals field 2920 which may indicate the time interval between consecutive Sub-SPs if the Sub-SP are also periodic.

Alternatively, instead of Action frames, the TWT Setup frames may also be encapsulated in ethertype 89-0d Data frames. This method avoids having to define new public Action frames for AP to AP TWT setups. Instead of including its TSF value/TSF offset in the TWT Setup request frame, the requesting AP may also calculate the Target Wake Time of the TWT SP based on the responding AP's TSF such that the Target Wake Time field in the TWT element indicates the actual start time from the responding AP's point of view and it need not do further adjustments to it.

The Sub-SP Non-Negotiable field 2914 may be set by the requesting AP to indicate to the responding AP its need for a quasi-guaranteed period of time during which the requesting AP should be able to access the channel with a very high probability. Such requests may be made, for example, for low latency traffic that are very sensitive to jitters. If the responding AP accepts the TWT request, it shall ensure that the AP or its associated STAs do not transmit during the Sub-SPs. The Sub-SP Start Offset field 2916 may indicate the time offset from the requested SP Start time till the start of the requested/assigned Sub-SP. Alternatively, the field may also indicate the actual TSF (Responding AP's) at which the first Sub-SP is requested to start.

Further, the Sub-SP Duration field 2918 may indicate the time duration of each Sub-SP. The Sub-SP Intervals field 2920 may indicate the time interval between consecutive Sub-SPs if the Sub-SP are also periodic and more than one Sub-SP occur within the requested TWT SP.

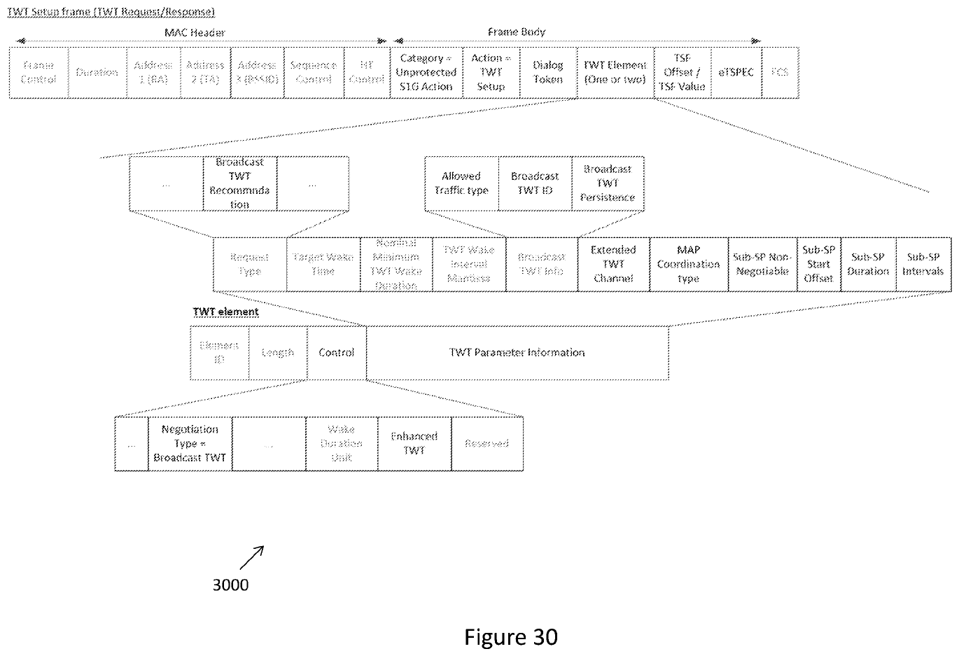

APs can thus join other AP's scheduled individual SPs of interest with the TWT Setup frame 2900. Alternatively, a Broadcast TWT Setup may also be used to join AP's existing scheduled SP. For example TWT Setup frame 3000 of FIG. 30 may be utilised in a manner similar to that discussed for TWT Setup frame 2900, enabling APs to join other AP's Scheduled broadcast SPs of interest.

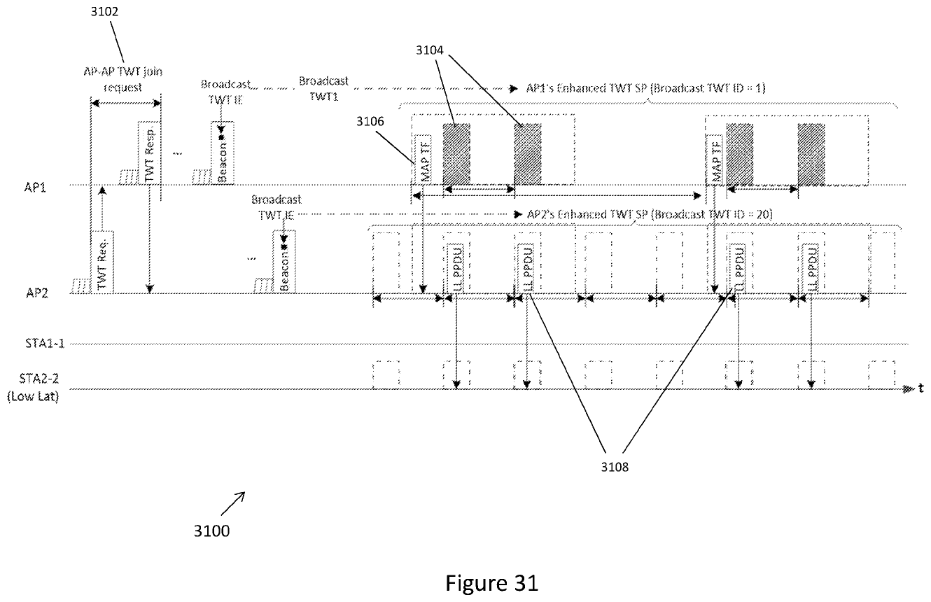

FIG. 31 shows an example diagram 3100 illustrating use of Sub-SPs to protect sensitive traffic (e.g. jitter sensitive low latency traffic). Phases of the example are as follows:
Phase 1: STA2-2 has negotiated periodic TWT SPs #20 with AP2 for jitter sensitive low latency traffics. The SPs are of short duration but occur frequently. Due to the jitter sensitivity of the traffic, AP2 needs to ensure that STA2-2's traffic are given preferential treatment during the SPs.
Phase 2A: AP2 requests at 3102 to join AP1's broadcast TWT #1
Phase 2B: AP2 requests to be allocated non-negotiable Sub-SPs 3104 within TWT #1
Phase 3: At the start of TWT #1, since AP2 is aware of AP1's TWT SP #1, it waits for MAP TF 3106 from AP1.
Phase 4: Within the TWT SP, AP1 shares its TXOP with AP2 (e.g. using C-TDMA) ensuring AP2 can gain access to the medium for transmission of the jitter sensitive traffic during AP2's TWT #20 SPs. Each AP may further protect the sub-SPs by transmitting Quiet element/Quiet Channel elements to respective associated STAs such that the sub-SPs are overlapped with quiet periods, ensuring that third party STAs do not transmit during the sub-SPs.
Phase 5: AP2 transmits/receive sensitive traffic 3108 to/from associated STA during the TWT #20 SPs that overlap with AP1's TWT #1.

It can be seen that the coordination of the TWT SPs among APs allow APs to effectively coordinate their transmission, even within an obtained TXOP and helps to alleviate the adverse effects of OBSS transmission on jitter sensitive traffic.

In example diagram 3100, it is assumed that AP2 has gathered information of AP1's TWT SPs either by passively listening to AP1's beacon frames or by actively probing AP1 for such information using SP info request/response frames. STA1-1 and STA2-1 are associated with AP1 and AP2 respectively. Since AP1's TWT SP #1 and AP2's TWT SP #20 may have different periodicity (as determined by the TWT Wake interval of each TWT agreement), the starting times of the requested sub-SPs may not be constant but vary for different occurrences of the TWT SP #1. AP1 need to calculate the start time of sub-SPs at the start of each new TWT SP #1 in order to ensure that they align with AP2's TWT SP #20. Alternatively, before every new instance of TWT SP #1, AP2 may notify AP1 of the correct start time for its request Sub-SPs, e.g. using TWT information frames. AP1 and AP2 may further protect the jitter sensitive traffics from each AP's associated STAs by transmitting Quiet Element/s or Quiet Channel Element/s in Beacon/Probe Response frames such that the BSS channels are quieted during the non-negotiable sub-SPs.

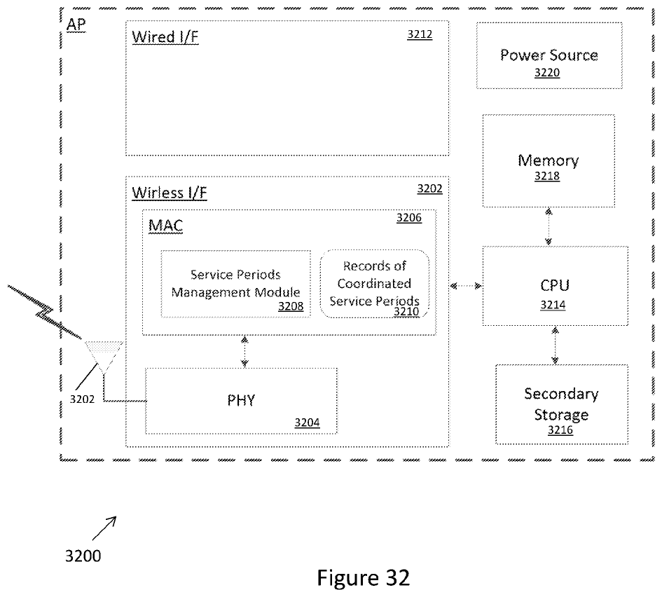

FIG. 32 shows a configuration of a communication device 3200, for example a communication apparatus, for example a Sharing AP or a Shared AP, according to various embodiments. The communication device 3200 may include at least one antenna 3202 for transmission and receipt of signals (for the sake of simplicity, only one antenna is shown in FIG. 32). The communication device may comprise a Wired OF module 3212, a Wireless OF module 3202, a Power Source 3220, at least one memory 3218, a central processing unit (CPU) 3214 comprising at least one processor and at least one secondary storage 3216. The Wireless OF module 3202 may further comprise a MAC sublayer 3206 and a PHY sublayer 3204. The MAC sublayer 3206 comprises a Service Periods Management Module 3208 that manages the Service Periods for associated STAs and keep a record of all such SPs in the Records of Coordinated Service Periods 3210. The Wireless I/F module 3212, the CPU 3214, the at least one memory 3218 and the at least one secondary storage 3216 may function together as circuitry of the communication device 3200 configured to generate TWT request frame, response frame, Trigger frame, Multi-STA BlockAck frame, DL MU PPDU, Beacon frame, DL PPDU, frame comprising a TWT element, RTS/CTS frame, TWT information frame, NSEP response frame, NSEP frame and TWT Setup frame for coordinated and priority traffic (i.e. low latency traffic) as described in the present disclosure. The antenna 3202 may then transmit the generated frame(s) or PPDU(s) to other communication apparatus, e.g. STA(s). The antenna 3202 may receive TWT request frame, response frame, PS-Poll frame, QoS Null frame, BlockAck frame, TB PPDU (i.e. UL PPDU), CTS frame, NSEP request frame, NSEP frame and TWT Setup frame from other communication device, i.e. STA(s) for coordinated and prioritized traffic (i.e. low latency traffic) as described in the present disclosure. The circuitry of the communication device 3200 may then be configured to process the received frame(s) or PPDU(s).

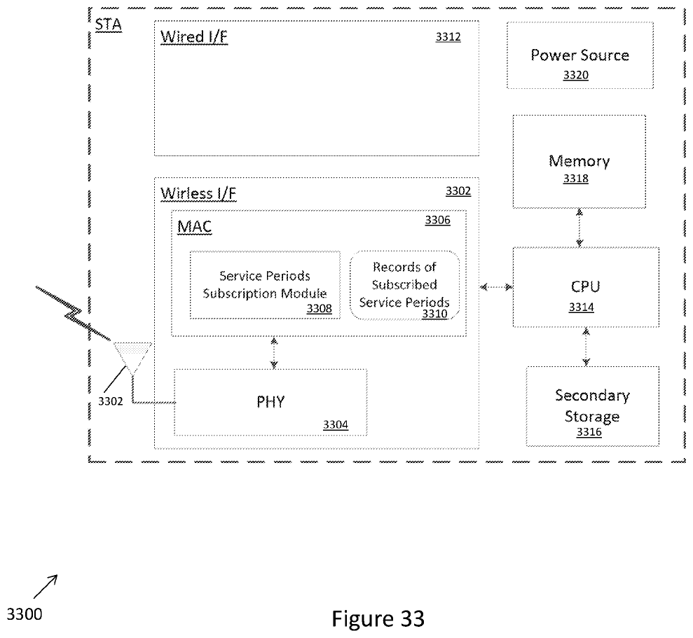

FIG. 33 shows a configuration of a communication device 3300, for example a communication apparatus, for example a non-AP STA, according to various embodiments. The communication device 3300 may include at least one antenna 3302 for transmission and receipt of signals (for the sake of simplicity, only one antenna is shown in FIG. 33). The communication device may comprise a Wired OF module 3312, a Wireless OF module 3302, a Power Source 3320, at least one memory 3318, a central processing unit (CPU) 3314 comprising at least one processor and at least one secondary storage 3316. The Wireless OF module 3302 may further comprise a MAC sublayer 3306 and a PHY sublayer 3304. The MAC sublayer 3306 comprises a Service Periods Management Module 3308 that manages the Service Periods of which the communication device 3300 is a member and keep a record of all such SPs in the Records of Coordinated Service Periods 3310. The Wireless OF module 3312, the CPU 3314, the at least one memory 3318 and the at least one secondary storage 3316 may function together as circuitry of the communication device 3300 configured to generate TWT request frame, response frame, PS-Poll frame, QoS Null frame, BlockAck frame, TB PPDU (i.e. UL PPDU), CTS frame, NSEP request frame, NSEP frame and TWT Setup frame for coordinated and priority traffic (i.e. low latency traffic) as described in the present disclosure. The antenna 3302 may then transmit the generated frame(s) or PPDU(s) to other communication devices, e.g. AP(s). The antenna 3202 may receive TWT response frame, Trigger frame, Multi-STA BlockAck frame, DL MU PPDU, Beacon frame, DL PPDU, frame comprising a TWT element, RTS/CTS frame, TWT information frame, NSEP response frame, NSEP frame and TWT Setup frame from other communication apparatus, i.e. AP(s) for coordinated and prioritized traffic (i.e. low latency traffic) as described in the present disclosure. The circuitry of the communication device 3300 may then be configured to process the received frame(s) or PPDU(s).

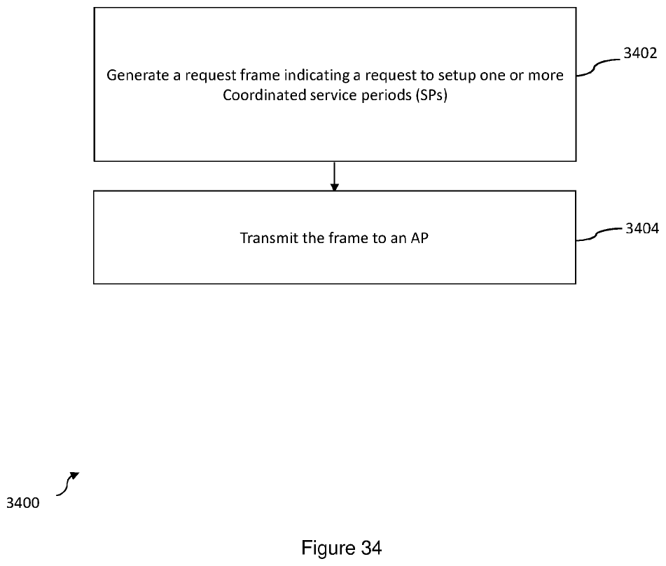

FIG. 34 shows a flow diagram 3400 illustrating a communication method according to various embodiments. At step 3402, a frame is generated indicating a request to setup one or more Coordinated SPs. At step 3404, the frame is transmitted to an AP.

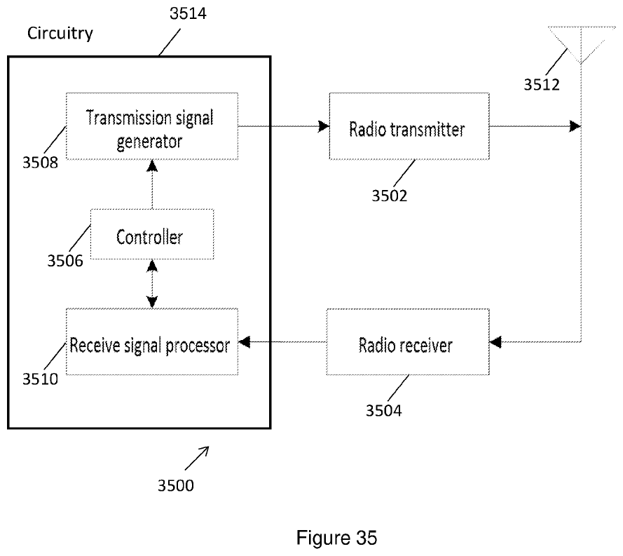

FIG. 35 shows a schematic, partially sectioned view of a communication apparatus 3500 that can be implemented for coordinated SPs. The communication apparatus 3500 may be implemented as a Sharing AP, Shared AP or an associated STA according to various embodiments.

Various functions and operations of the communication apparatus 3500 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 35, the communication apparatus 3500 may include circuitry 3514, at least one radio transmitter 3502, at least one radio receiver 3504 and multiple antennas 3512 (for the sake of simplicity, only one antenna is depicted in FIG. 35 for illustration purposes). The circuitry may include at least one controller 3506 for use in software and hardware aided execution of tasks it is designed to perform, including control of communications with one or more other multi-link devices in a MIMO wireless network. The at least one controller 3506 may control at least one transmission signal generator 3508 for generating frames to be sent through the at least one radio transmitter 3502 to one or more other STAs, APs or AP multi-link devices (MLDs) and at least one receive signal processor 3510 for processing frames received through the at least one radio receiver 3504 from the one or more other STAs, APs or AP MLDs. The at least one transmission signal generator 3508 and the at least one receive signal processor 3510 may be stand-alone modules of the communication apparatus 3500 that communicate with the at least one controller 3506 for the above-mentioned functions. Alternatively, the at least one transmission signal generator 3508 and the at least one receive signal processor 3510 may be included in the at least one controller 3506. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 3502, at least one radio receiver 3504, and at least one antenna 3512 may be controlled by the at least one controller 3506. Furthermore, while only one radio transmitter 3502 is shown, it will be appreciated that there can be more than one of such transmitters.

In various embodiments, when in operation, the at least one radio receiver 3504, together with the at least one receive signal processor 3510, forms a receiver of the communication apparatus 3500. The receiver of the communication apparatus 3500, when in operation, provides functions required for multi-link communication. While only one radio receiver 3504 is shown, it will be appreciated that there can be more than one of such receivers.

The communication apparatus 3500, when in operation, provides functions required for Coordinated SPs. For example, the communication apparatus 3500 may be a first AP. The circuitry 3514 may, in operation, generate a request frame indicating a request to setup one or more Coordinated SPs. The transmitter 3502 may, in operation, transmit the request frame to a second AP.

The receiver 3504 may, in operation, receive a response frame from the second AP, the response frame indicating acceptance of the request to setup one or more Coordinated SPs; wherein the transmitter 3502 may be further configured to transmit frames to one or more associated STAs to setup Scheduled SPs that overlap with the Coordinated SPs. The request frame, the response frame and the frames may be TWT Setup frames and the Coordinated SPs may be TWT SPs. The TWT Setup frames carry an indication that the Coordinated SPs are for Multi-AP Coordinated transmissions, and further carry a timing synchronization function (TSF) value of the AP transmitting the TWT Setup frames. The TWT Setup frames received from the second AP may also carry identity information of one or more other APs that are also members of the Coordinated SPs. The TWT Setup frames may indicate, in a TWT channel field and a TWT Extended channel field in a TWT element of each TWT Setup frame, sub-channels requested by the first AP or assigned to the first AP by the second AP, the sub-channels being sub-sets of operating channels of the second AP. The TWT Setup frames may indicate, in a TWT element of each TWT Setup frame, a starting time offset, a time duration and intervals of one or more sub-SPs that are requested by the first AP or assigned to the first AP by the second AP, the sub-SPs being a portion of the Coordinated SPs. The first AP may be the only AP allowed by the second AP to transmit in the assigned sub-channels, or the assigned sub-SPs during a shared TXOP for Multi-AP Coordinated transmission initiated by the second AP.

The first AP may be further configured to participate in a shared TXOP for Multi-AP Coordinated transmission initiated by the second AP within a Coordinated SP, and wherein the transmitter 3502 of the first AP may be further configured to transmit frames to its associated STAs in a coordinated manner with the second AP. The transmitter 3502 may be further configured to transmit, at a start of a shared TXOP, a frame reporting a DL & UL buffer status of its BSS to the second AP. The Multi-AP Coordinated transmission may be one of a C-OFDMA transmission, C-TDMA transmission, C-SR transmission, C-BF transmission or Coordinated MU-MIMO transmission. The circuitry 3514 may be further configured to determine a suitable type of Multi-AP Coordinated transmission for each associated STA, and wherein the transmitter 3502 may be further configured to transmit frames to the associated STAs to setup Scheduled SPs that overlap with corresponding Coordinated SPs based on the determined Multi-AP Coordinated transmission types, the request frame and the frames being TWT Setup frames. The TWT Setup frames may indicate, in a TWT channel field and a TWT Extended channel field in a TWT element of each TWT Setup frame, sub-channels requested by the first AP or assigned to the first AP by the second AP, the sub-channels being sub-sets of operating channels of the second AP. The TWT Setup frames may indicate, in a TWT element of each TWT Setup frame, a starting time offset, a time duration and intervals of one or more sub-SPs that are requested by the first AP or assigned to the first AP by the second AP, the sub-SPs being a portion of the Coordinated SPs. The first AP may be the only AP allowed by the second AP to transmit in the assigned sub-channels, or the assigned sub-SPs during a shared TXOP for Multi-AP Coordinated transmission initiated by the second AP.

The receiver 3504 may, in operation, receive a frame transmitted by the second AP, the frame being one of a Beacon frame, Action frame or Data frame; and wherein the circuitry 3514 may be further configured to extract information of SPs associated with the second AP from the received frame. The SPs may be TWT SPs. The transmitter 3502 may be further configured to transmit a TWT Setup Request frame to the second AP for requesting to join one or more of the second AP's associated SPs. The transmitter 3502 may be further configured to transmit frames to one or more associated STAs to setup Scheduled SPs that do not overlap with the second AP's associated SPs. The TWT Setup frames may indicate, in a TWT channel field and a TWT Extended channel field in a TWT element of each TWT Setup frame, sub-channels requested by the first AP or assigned to the first AP by the second AP, the sub-channels being sub-sets of operating channels of the second AP. The TWT Setup frames may indicate, in a TWT element of each TWT Setup frame, a starting time offset, a time duration and intervals of one or more sub-SPs that are requested by the first AP or assigned to the first AP by the second AP, the sub-SPs being a portion of the Coordinated SPs. The first AP may be the only AP allowed by the second AP to transmit in the assigned sub-channels, or the assigned sub-SPs during a shared TXOP for Multi-AP Coordinated transmission initiated by the second AP.

The communication apparatus 3500 may be a non-AP STA. The receiver 3504 may, in operation, receive one of a Beacon frame or Action frame from its associated AP. The circuitry 3514 may, in operation, extract information of SPs for coordinated transmissions from the frame. The transmitter 3502 may, in operation, transmit a request frame to the AP, the request frame indicating a request to join the SPs. The SPs may be TWT SPs and the request frame may be a TWT Setup Request frame.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an AP MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID). The following statements are described in the present disclosure:
Statement 1. A first Access Point (AP) comprising:
circuitry, which in operation, generates a request frame indicating a request to setup one or more Coordinated service periods (SPs); and a transmitter, which in operation, transmits the request frame to a second AP.
Statement 2. The first AP of Statement 1, further comprising a receiver, which in operation, receives a response frame from the second AP, the response frame indicating acceptance of the request to setup one or more Coordinated SPs; wherein the transmitter is further configured to transmit frames to one or more associated stations (STAs) to setup Scheduled SPs that overlap with the Coordinated SPs.
Statement 3. The first AP of Statement 2, wherein the request frame, the response frame and the frames are target wait time (TWT) Setup frames and the Coordinated SPs are TWT SPs.
Statement 4. The first AP of Statement 3, wherein the TWT Setup frames carry an indication that the Coordinated SPs are for Multi-AP Coordinated transmissions, and further carry a timing synchronization function (TSF) value of the AP transmitting the TWT Setup frames.
Statement 5. The first AP of Statement 3, wherein the TWT Setup frames received from the second AP also carries identity information of one or more other APs that are also members of the Coordinated SPs.
Statement 6. The first AP of Statement 1, wherein the first AP is further configured to participate in a shared TXOP for Multi-AP Coordinated transmission initiated by the second AP within a Coordinated SP, and wherein the transmitter of the first AP is further configured to transmit frames to its associated STAs in a coordinated manner with the second AP.
Statement 7. The first AP of Statement 6, wherein the transmitter is further configured to transmit, at a start of a shared TXOP, a frame reporting a downlink (DL) & uplink (UL) buffer status of its basic service set (BSS) to the second AP.
Statement 8. The first AP of Statement 6, wherein the Multi-AP Coordinated transmission is one of a Coordinated-orthogonal frequency division multiple access (OFDMA) transmission, Coordinated-time division multiple access (TDMA) transmission, Coordinated-spatial reuse (SR) transmission, Coordinated-Beamforming (BF) transmission or Coordinated multi-user multiple input, multiple output (MU-MIMO) transmission.
Statement 9. The first AP of Statement 8, wherein the circuitry is further configured to determine a suitable type of Multi-AP Coordinated transmission for each associated STA, and wherein the transmitter is further configured to transmit frames to the associated STAs to setup Scheduled SPs that overlap with corresponding Coordinated SPs based on the determined Multi-AP Coordinated transmission types, the request frame and the frames being TWT Setup frames.
Statement 10. The first AP of Statement 1, further comprising a receiver, which in operation, receives a frame transmitted by the second AP, the frame being one of a Beacon frame, Action frame or Data frame; and wherein the circuitry is further configured to extract information of SPs associated with the second AP from the received frame.
Statement 11. The first AP of Statement 10, wherein the SPs are TWT SPs.
Statement 12. The first AP of Statement 11, wherein the transmitter is further configured to transmit a TWT Setup Request frame to the second AP for requesting to join one or more of the second AP's associated SPs.
Statement 13. The first AP of Statement 10, wherein the transmitter is further configured to transmit frames to one or more associated STAs to setup Scheduled SPs that do not overlap with the second AP's associated SPs.
Statement 14. The first AP of Statements 3, 9 and 12, wherein the TWT Setup frames indicate, in a TWT channel field and a TWT Extended channel field in a TWT element of each TWT Setup frame, sub-channels requested by the first AP or assigned to the first AP by the second AP, the sub-channels being sub-sets of operating channels of the second AP.
Statement 15. The first AP of Statements 3, 9 and 12, wherein the TWT Setup frames indicate, in a TWT element of each TWT Setup frame, a starting time offset, a time duration and intervals of one or more sub-SPs that are requested by the first AP or assigned to the first AP by the second AP, the sub-SPs being a portion of the Coordinated SPs.
Statement 16. The first AP of Statements 14 and 15, wherein the first AP is the only AP allowed by the second AP to transmit in the assigned sub-channels, or the assigned sub-SPs during a shared TXOP for Multi-AP Coordinated transmission initiated by the second AP.
Statement 17. A non-AP STA, comprising:
a receiver, which in operation, receives one of a Beacon frame or Action frame from its associated AP;
circuitry, which in operation, extracts information of SPs for coordinated transmissions from the frame; and
a transmitter, which in operation, transmits a request frame to the AP, the request frame indicating a request to join the SPs.
Statement 18. The non-AP STA of Statement 17, wherein the SPs are TWT SPs and the request frame is a TWT Setup Request frame.
Statement 19. A method comprising:
generating a request frame indicating a request to setup one or more Coordinated service periods (SPs); and
transmitting the request frame to an AP.

Thus, it can be seen that the present embodiments provide communication devices and methods for Coordinated SPs.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first Access Point (AP) comprising:
circuitry, which in operation, generates a request frame indicating a request to setup one or more Coordinated service periods (SPs); and
a transmitter, which in operation, transmits the request frame to a second AP.

2. The first AP of claim 1, further comprising a receiver, which in operation, receives a response frame from the second AP, the response frame indicating acceptance of the request to setup one or more Coordinated SPs; wherein the transmitter is further configured to transmit frames to one or more associated stations (STAs) to setup Scheduled SPs that overlap with the Coordinated SPs.

3. The first AP of claim 2, wherein the request frame, the response frame and the frames are target wait time (TWT) Setup frames and the Coordinated SPs are TWT SPs.

4. The first AP of claim 3, wherein the TWT Setup frames carry an indication that the Coordinated SPs are for Multi-AP Coordinated transmissions, and further carry a timing synchronization function (TSF) value of the AP transmitting the TWT Setup frames.

5. The first AP of claim 3, wherein the TWT Setup frames received from the second AP also carries identity information of one or more other APs that are also members of the Coordinated SPs.

6. The first AP of claim 1, wherein the first AP is further configured to participate in a shared TXOP for Multi-AP Coordinated transmission initiated by the second AP within a Coordinated SP, and wherein the transmitter of the first AP is further configured to transmit frames to its associated STAs in a coordinated manner with the second AP.

7. The first AP of claim 6, wherein the transmitter is further configured to transmit, at a start of a shared TXOP, a frame reporting a downlink (DL) & uplink (UL) buffer status of its basic service set (BSS) to the second AP.

8. The first AP of claim 6, wherein the Multi-AP Coordinated transmission is one of a Coordinated-orthogonal frequency division multiple access (OFDMA) transmission, Coordinated-time division multiple access (TDMA) transmission, Coordinated-spatial reuse (SR) transmission, Coordinated-Beamforming (BF) transmission or Coordinated multi-user multiple input, multiple output (MU-MIMO) transmission.

9. The first AP of claim 8, wherein the circuitry is further configured to determine a suitable type of Multi-AP Coordinated transmission for each associated STA, and wherein the transmitter is further configured to transmit frames to the associated STAs to setup Scheduled SPs that overlap with corresponding Coordinated SPs based on the determined Multi-AP Coordinated transmission types, the request frame and the frames being TWT Setup frames.

10. The first AP of claim 1, further comprising a receiver, which in operation, receives a frame transmitted by the second AP, the frame being one of a Beacon frame, Action frame or Data frame; and wherein the circuitry is further configured to extract information of SPs associated with the second AP from the received frame.

11. The first AP of claim 10, wherein the SPs are TWT SPs.

12. The first AP of claim 11, wherein the transmitter is further configured to transmit a TWT Setup Request frame to the second AP for requesting to join one or more of the second AP's associated SPs.

13. The first AP of claim 10, wherein the transmitter is further configured to transmit frames to one or more associated STAs to setup Scheduled SPs that do not overlap with the second AP's associated SPs.

14. A non-AP STA, comprising:
a receiver, which in operation, receives one of a Beacon frame or Action frame from its associated AP;
circuitry, which in operation, extracts information of SPs for coordinated transmissions from the frame; and
a transmitter, which in operation, transmits a request frame to the AP, the request frame indicating a request to join the SPs.

15. A method comprising:
generating a request frame indicating a request to setup one or more Coordinated service periods (SPs); and
transmitting the request frame to an AP.
